(19) United States
(12) Patent Application Publication
(10) Pub. No.: US 2022/0058285 A1
(43) Pub. Date: Feb. 24, 2022

(54) SYSTEMS AND METHODS FOR COMPUTER-IMPLEMENTED DATA TRUSTS

(71) Applicant: Sightline Innovation Inc., Toronto (CA)

(72) Inventors: Wallace Trenholm, Etobicoke (CA); Maithili Mavinkurve, Markham (CA); Mark Alexiuk, Winnipeg (CA); Jason Haydaman, Winnipeg (CA)

(21) Appl. No.: 17/416,912

(22) PCT Filed: Dec. 19, 2019
(86) PCT No.: PCT/CA2019/051858

§ 371 Date: Jun. 21, 2021

Related U.S. Application Data
(60) Provisional application No. 62/783,776, filed on Dec. 21, 2018.

(51) Int. Cl. G06F 21/62; G06F 16/27; G06N 20/00

(52) U.S. Cl. CPC G06F 21/6218; G06N 20/00; G06F 16/27

(57) ABSTRACT

Systems and methods for a computer-implemented data trust are provided. A system for providing a data trust for a data asset includes a data trust domain. The data trust domain includes a parent node associated with a trustee. The trustee administers the data trust. The data trust domain also includes a plurality of data partner nodes. The data partner nodes include at least one data producer node associated with a data producer and at least one data consumer node associated with a data consumer. The nodes in the data trust domain are communicatively connected to each other via a network. The data trust is administered according to a set of governance rules. The set of governance rules is defined in a smart contract.

### TECHNICAL FIELD

The following relates generally to data sharing, and more particularly to systems and methods for a computer-implemented data trust for controlling data assets between trusted data partners.

### INTRODUCTION

Data governance is becoming an increasingly important public policy issue. Data has become the new enterprise currency. Data is becoming an increasingly valuable asset. Data stockpiles built with raw, meta and derived data generated by smartphones, satellites, enterprise engines, IoT devices, as well as through traditional research and data collection methods are proliferating at a significant rate. Data companies have replaced oil and energy companies as the most valuable firms in the world. The global data economy is pegged at $3 trillion.

Various industries including retail, financial services, travel, agriculture, security, defence, health and public services are increasingly relying on data-driven systems to drive business decisions and service delivery.

In the public domain, there is an increasing need to ensure data is used for the purposes it was intended for, such as to benefit the citizens. To capture the full value of data assets, trust in the data should be maintained in respect of how the data is collected, stored, shared and used.

Current approaches to data governance and sharing suffer from challenges. The creation of data sharing agreements is a slow and manual process that can create friction in business processes. Existing data sharing processes are static, with data shared at specific times and with no real time access. Data flow processes can be cumbersome across data producers and consumers, which can limit the breadth of data flow and statistical analysis. The costs of warehousing and cloud services are rising. Further, using current approaches, uncertainty often surrounds the allocation of rights including ownership of and transfer of access rights to data assets.

Centralized approaches to data governance and sharing rely heavily on a single actor: the trustee of the data. Such approaches require that the governing or holding party have significant trust from the data partners.

An open, transparent and robust data trust and trading system is required to reap the economic and social prosperity benefits from data, particularly data derived from AI processes.

Setting up contracts to do data sharing among data partners including contract evolution, lawyering process, and physically just getting the data.

Accordingly, there is a need for an improved system and method for secure data sharing and exchange that overcomes at least some of the disadvantages of existing systems and methods.

### SUMMARY

Other aspects and features will become apparent, to those ordinarily skilled in the art, upon review of the following description of some exemplary embodiments.

A system for providing a data trust for a data asset is provided herein. The system includes a data trust domain. The data trust domain includes a parent node associated with a trustee. The trustee administers the data trust. The data trust domain also includes a plurality of data partner nodes. The data partner nodes include at least one data producer node associated with a data producer and at least one data consumer node associated with a data consumer. The nodes in the data trust domain are communicatively connected to each other via a network. The data trust is administered according to a set of governance rules. The set of governance rules is defined in a smart contract. The smart contract is executed on a distributed ledger network. Access to the data asset is provided from the at least one data producer node to the at least one data consumer node according to the set of governance rules.

The parent node may include a distributed ledger node.

The at least one data partner node may include a distributed ledger node.

The network may be a software-defined wide area network.

The data trust domain may be listed in a root network. The root network may be connected to the data trust domain via the network. The root network may be configured to store a list of data trust domains.

The root network may be configured to maintain a global lookup system.

The data asset may be a machine learning data asset.

At least one data partner node may be communicatively linked to an AI engine for generating data assets.

The at least one data producer node may be communicatively linked to an AI engine for generating the data asset.

The at least one data consumer node may be communicatively linked to an AI engine for generating a derivative data asset using the data asset.

The derivative data asset may be provisioned to the data trust domain.

The distributed ledger network may be a permissioned distributed ledger network.

The permissioned distributed ledger may include an access control layer.

The access control layer may control which nodes are permitted to participate in smart contract creation.

The access control layer may control which nodes are permitted to participate in validation tasks.

The set of governance rules may include at least one rule relating to remuneration of the data producer.

The data asset may be rendered in a user interface of the at least one data consumer node.

The user interface may include a point-and-click interface.

The governance rules may define access rights to the data asset for at least one data partner.

The at least one data partner node may be a data partner node in a second data trust domain.

A computing device may execute a smart contract over the system.

A computing device for use in a computer-implemented data trust for a data asset is provided herein. The computing device includes a memory for storing the data asset and a computer processor. The computing device is a data partner node in a data trust domain. The computing device is communicatively connected to a plurality of other nodes in the data trust domain via a network. The plurality of other nodes include a parent node associated with a trustee and at least one other data partner node. The data asset is subject to a smart contract. The smart contract defines a set of governance rules for the data trust. The smart contract is executed on a distributed ledger network.

A method of providing controlled access to a data asset via a computer-implemented data trust is provided herein. The method includes creating a data trust domain. The data trust domain includes a plurality of nodes communicatively connected to each other via a network. The plurality of nodes include a parent node associated with a trustee. The trustee administers the data trust. The parent node includes a distributed ledger node. The plurality of nodes include a plurality of data partner nodes including at least one data producer node associated with a data producer and at least one data consumer node associated with a data consumer. The method also includes defining a smart contract for the data asset. The smart contract defines a set of governance rules for the data asset. The method also includes provisioning the data asset to the data trust domain in such a way that the data asset is accessible to the at least one data consumer node according to the smart contract.

The network may include a software-defined wide area network.

The method may further include provisioning a second data asset to the data trust domain. The second data asset may include a derivative data asset generated using the data asset.

### BRIEF DESCRIPTION OF THE DRAWINGS

The drawings included herewith are for illustrating various examples of articles, methods, and apparatuses of the present specification. In the drawings:

FIG. 1 is a schematic diagram of a system for providing a computer-implemented data trust, according to an embodiment;

FIG. 2 is a block diagram of a computing device of the system of FIG. 1;

FIG. 3 is a diagrammatic representation of a data trust, according to an embodiment;

FIG. 4 is a schematic/block diagram of a data trust system, according to an embodiment;

FIG. 5 is a block diagram of an Al engine for use at a data trust domain node, according to an embodiment;

FIG. 6 is a flowchart of a method of using the data trust system of FIG. 4, according to an embodiment;

FIG. 7 is a flowchart of a method of creating a data trust using the system of FIG. 3, according to an embodiment;

FIG. 8 is a flowchart of a method of joining a data trust using the system of FIG. 3, according to an embodiment;

FIG. 9 shows an example user interface landing page for logging into the data trust system, according to an embodiment;

FIG. 10 shows an example user interface for a data trust system, according to an embodiment;

FIG. 11 shows an example user interface for a data trust system, according to an embodiment;

FIG. 12 shows an example user interface for a data trust system, according to an embodiment;

FIG. 13 shows an example user interface for a data trust system, according to an embodiment;

FIG. 14 shows an example user interface for a data trust system, according to an embodiment;

FIG. 15 shows an example user interface for a data trust system, according to an embodiment;

FIG. 16 shows an example user interface for a data trust system, according to an embodiment;

FIG. 17 shows an example user interface for a data trust system, according to an embodiment;

FIG. 18 shows an example user interface for a data trust system, according to an embodiment;

FIG. 19 shows an example user interface for a data trust system, according to an embodiment;

FIG. 20 shows an example user interface for a data trust system, according to an embodiment;

FIG. 21 shows an example user interface for a data trust system, according to an embodiment;

FIG. 22 shows an example user interface for a data trust system, according to an embodiment;

FIG. 23 shows an example user interface for a data trust system, according to an embodiment;

FIG. 24 shows an example user interface for a data trust system, according to an embodiment;

FIG. 25 shows an example user interface for a data trust system, according to an embodiment;

FIG. 26 shows an example user interface for a data trust system, according to an embodiment;

FIG. 27 shows an example user interface for a data trust system, according to an embodiment; and

FIG. 28 shows an example user interface for a data trust system, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

The following relates generally to data control and access, and more particularly to systems and methods for a computer implemented data trust for secure data sharing and exchange.

The system provides a secure data exchange network and smart contract system that provides a user with control over data and a means to monetize the data. The system provides control of data assets between trusted data partners. The system includes a distributed software infrastructure for enabling data partners to share and exchange data assets in accordance with data trust policies and governance structures.

The system may provide automated data sharing agreements. The system may provide real time and automated data and analytics. The system may include low latency during data transfer cycles. The system may include connectivity to edge data collection and processing (e.g. mobile technology).

The systems and methods disclosed herein may provide automated and cost-effective data management and oversight. Data import, transfer, and access processes are automated and may occur across multiple technologies, including real-time interactions with mobile technologies. The system may provide cost-effective and distributed data warehousing and storage capabilities. The system may optimize data transfer cycles to process high volumes of data with minimal delay (a low latency computer network). The system may include a maximized data update frequency. The maximized data update frequency may provide higher time-granularity analysis. The processing of data using the system is flexible and distributed, which can optimize analysis and reduce costs.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

There is described a system for performing secure data asset sharing and exchange using a computer-implemented data trust. Access rights can be defined between data partners. Data assets may include data assets derived from or used in an artificial intelligence or machine learning process (“AI data assets”). AI data assets may include datasets, derivative datasets, analytics, and machine learning models. Sharing and exchange of data assets are governed by trust policies implemented by smart contracts. For example, the system can be used to provide secure access to a data asset of a data provider to a data consumer.

Data assets managed (i.e. shared, exchanged, etc.) using the system may be referred to throughout the present disclosure as “data assets” or “data” and are understood to include any data or model created, produced, generated, used, or modified throughout the machine learning or AI lifecycle. For example, data assets include datasets, derivative datasets, analytics, and machine learning models. Datasets may be used to train machine learning models. Data assets may be created using one or more components of the system or components connected to the system, such as an Al engine. The data assets controlled by the system may be in existence at the time of data trust formation or may be generated after data trust formation, such as by one or more nodes in the system.

The systems and methods for providing a computer-implemented data trust provided herein follow a trust model. A trust in the traditional sense of the word is a three-party relationship where an asset is transferred from a Grantor to a Beneficiary through a Trustee. The systems and methods of the present disclosure take the traditional trust concept further by implementing a data trust that establishes a technology framework that enables control and sovereignty of data assets between trusted data partners.

Generally, in the systems and methods of the present disclosure, a data trust is created by a trustee. The data trust includes a data trust domain. The trustee specifies the policies and rules of the data trust, which are implemented in a smart contract using distributed ledger technology. Permissioned trust parties can join the data trust domain. Data partners in the data trust domain may want to share data assets using the data trust system, access or use data assets of other trust parties for their own purposes (e.g. analysis), or both. Provision and use of data assets by the trust parties is strictly controlled by the data trust system, such that provision and use only occur pursuant to the trust rules and policies.

The system may be configured to provision SD-WANs for the purposes of blockchain or distributed ledger-based interprocess communication for the purposes of distributing data assets (AI data assets).

In an embodiment, the system includes an Al lifecycle tool that uses SD-WAN for intersite communication with a distributed ledger component.

In a particular case, the systems and methods of the present disclosure can be used to make a data asset created using a first computing device including Al engine accessed through a point-and-click interface accessible (i.e. visible and useable) on a second computing device in a secure manner. The second computing device may also include an Al engine accessible through a point-and-click interface.

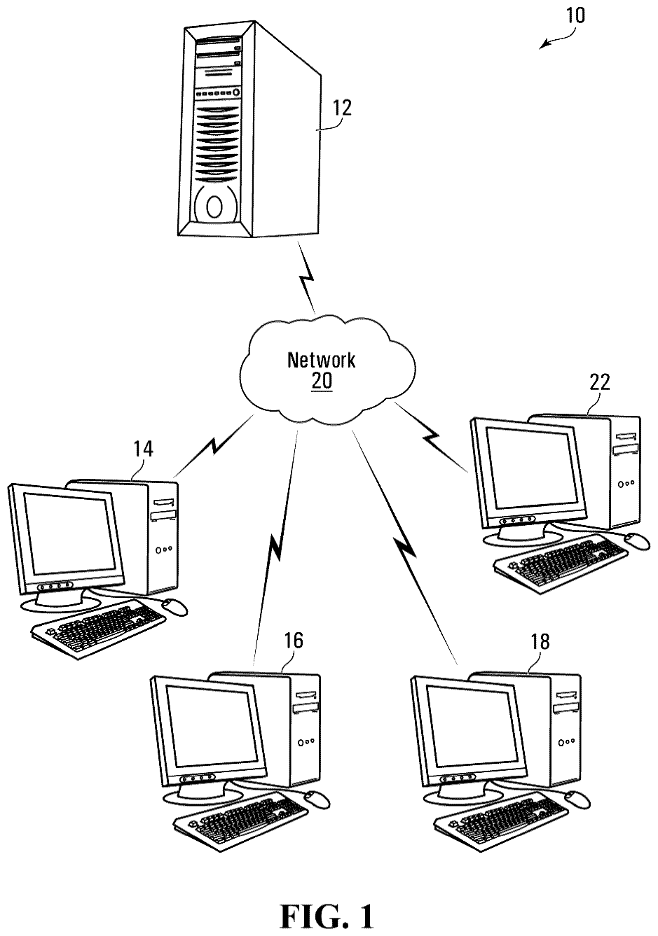

Referring now to FIG. 1, shown therein is a block diagram illustrating a system 10, in accordance with an embodiment. The system 10 includes a server platform 12 which communicates with a plurality of data provider devices 14, a plurality of data consumer devices 16, and a plurality of administrator (or trustee) devices 18 via a network 20. Devices 14, 16, 18 may be collectively referred to as “trust party devices”. Devices 14, 16 may be collectively referred to as “data partner devices”. The server platform 12 may communicate with a plurality of distributed ledger computers 22 via the network. The server platform 12 may be a purpose built machine designed specifically for providing a computer-implemented data trust for sharing and exchange of data assets between data partners (i.e. data providers and data consumers).

The server platform 12, data provider devices 14, data consumer devices 16, administrator devices 18 and distributed ledger computers 22 may be a server computer, desktop computer, notebook computer, tablet, PDA, smartphone, or another computing device. The devices 12, 14, 16, 18, 22 may include a connection with the network 20 such as a wired or wireless connection to the Internet. In some cases, the network 20 may include other types of computer or telecommunication networks. The network 20 may be a wide area network (WAN). The network 20 may be a private network, such as a virtual private network (VPN). The network 20 may be a software-defined WAN. The devices 12, 14, 16, 18, 22 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage, or may be received from the Internet or other network 20. Input device may include any device for entering information into device 12, 14, 16, 18, 22. For example, input device may be a keyboard, key pad, cursor-control device, touch-screen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 12, 14, 16, 18, 22 may include multiple of any one or more of processors, applications, software modules, second storage devices, network connections, input devices, output devices, and display devices.

Although devices 12, 14, 16, 18, 22 are described with various components, one skilled in the art will appreciate that the devices 12, 14, 16, 18, 22 may in some cases contain fewer, additional or different components. In addition, although aspects of an implementation of the devices 12, 14, 16, 18, 22 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18, 22 and/or processor to perform a particular method.

In the description that follows, devices such as server platform 12, data provider devices 14, data consumer devices 16, administrator devices 18, and distributed ledger computers 22 are described performing certain acts. It will be appreciated that any one or more of these devices may perform an act automatically or in response to an interaction by a user of that device. That is, the user of the device may manipulate one or more input devices (e.g. a touchscreen, a mouse, or a button) causing the device to perform the described act. In many cases, this aspect may not be described below, but it will be understood.

As an example, it is described below that the devices 12, 14, 16, 18, 22 may send information to the server platform 12. For example, a data provider using the data provider device 14 may manipulate one or more input devices (e.g. a mouse and a keyboard) to interact with a user interface displayed on a display of the data provider device 14. Generally, the device may receive a user interface from the network 20 (e.g. in the form of a webpage). Alternatively or in addition, a user interface may be stored locally at a device (e.g. a cache of a webpage or a mobile application).

Server platform 12 may be configured to receive a plurality of information, from each of the plurality of data provider devices 14, data consumer devices 16, administrator devices 18, and distributed ledger computers 22. Generally, the information may comprise at least an identifier identifying the data provider, data consumer, administrator, or distributed ledger computer. For example, the information may comprise one or more of a username, e-mail address, password, social media handle, or the like.

In response to receiving information, the server platform 12 may store the information in storage database. The storage may correspond with secondary storage of the device 12, 14, 16, 18, 22. Generally, the storage database may be any suitable storage device such as a hard disk drive, a solid state drive, a memory card, or a disk (e.g. CD, DVD, or Blu-ray etc.). Also, the storage database may be locally connected with server platform 12. In some cases, storage database may be located remotely from server platform 12 and accessible to server platform 12 across a network for example. In some cases, storage database may comprise one or more storage devices located at a networked cloud storage provider.

The data provider device 14 may be associated with a data provider account. Similarly, the data consumer device 16 may be associated with a data consumer account, the administrator device 18 may be associated with an administrator account, and the distributed ledger computer 22 may be associated with a distributed ledger computer account. Any suitable mechanism for associating a device with an account is expressly contemplated. In some cases, a device may be associated with an account by sending credentials (e.g. a cookie, login, or password etc.) to the server platform 12. The server platform 12 may verify the credentials (e.g. determine that the received password matches a password associated with the account). If a device is associated with an account, the server platform 12 may consider further acts by that device to be associated with that account.

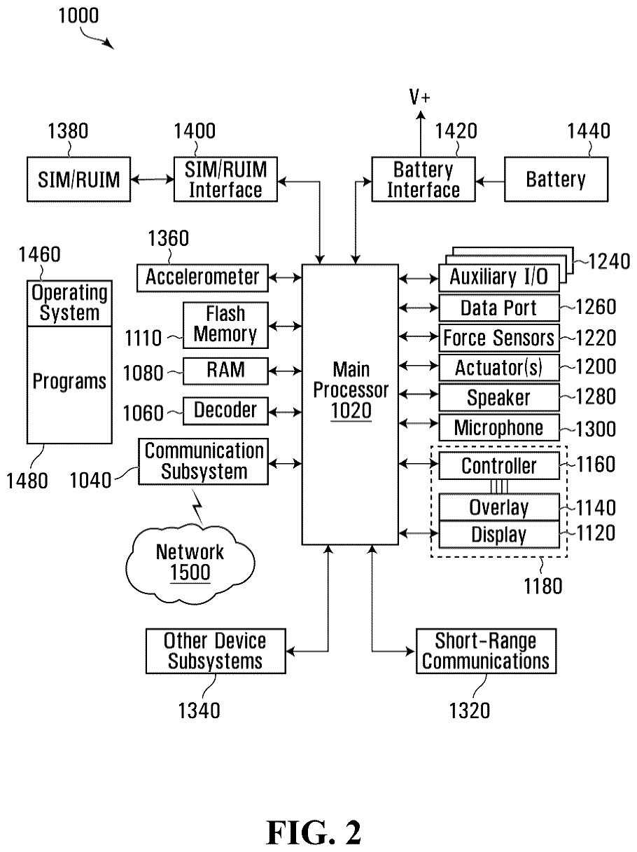

Referring now to FIG. 2, shown therein is a simplified block diagram of components of a computing device 1000, according to an embodiment. The computing device 1000 may be a mobile device or portable electronic device. The computing device 1000 may be any of devices 12, 14, 16, 18, 22 of FIG. 1. The computing device 1000 includes multiple components such as a processor 1020 that controls the operations of the computing device 1000. Communication functions, including data communications, voice communications, or both may be performed through a communication subsystem 1040. Data received by the computing device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The computing device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1100, a display 1120 (e.g. with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a portable electronic device generated by the processor 102 may be displayed on the touch-sensitive display 118.

The processor 1020 may also interact with an accelerometer 1360 as shown in FIG. 2. The accelerometer 1360 may be utilized for detecting direction of gravitational forces or gravity-induced reaction forces.

To identify a subscriber for network access according to the present embodiment, the computing device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1100 or performed using other techniques.

The computing device 1000 also includes an operating system 1460 and software components 1480 that are executed by the processor 1020 and which may be stored in a persistent data storage device such as the flash memory 1100. Additional applications may be loaded onto the portable electronic device 1000 through the wireless network 1500, the auxiliary I/O subsystem 1240, the data port 1260, the short-range communications subsystem 1320, or any other suitable device subsystem 1340.

In use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the portable electronic device 1000 may be similar. The speaker 1280 may output audible information converted from electrical signals, and the microphone 1300 may convert audible information into electrical signals for processing.

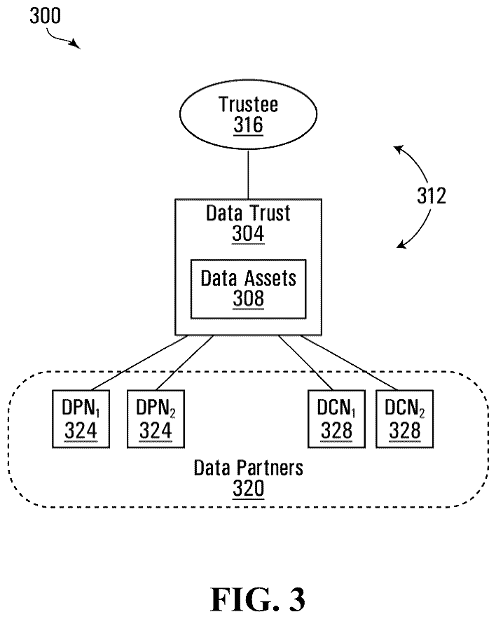

Referring now to FIG. 3, shown therein is a diagrammatic representation of a data trust system 300 for sharing and exchanging data assets, according to an embodiment.

The data trust system 300 implements a data trust 304 for a plurality of data assets 308. The data trust 304 is implemented for the benefit of a plurality of data partners 310. The data trust system 300 includes components and features that promote the secure sharing and exchange of the data assets 308 between the data partners 310. The data trust 304 includes policies and rules regarding the sharing and use of the data assets 308 by the data partners 310.

The data trust 304 includes a plurality of trust parties 312. A trust party 312 may be an individual or an organization. The trust parties 312 include a trustee 316 and the data partners 310.

The trustee 316 administers and manages the data assets 308 in the data trust 304. The trustee 316 defines governance policies, rules, and regulations for the data assets 308.

The data partners 310 are parties that want to access another party's data assets or monetize their own data assets. The data partners 310 include a plurality of data providers (DPN) 324 and a plurality of data consumers (DCN) 328. In some cases, a data partner 310 may be a data provider 324 and a data consumer 328.

The data provider 324 provides data assets 308 to the data trust 304. The data provider 324 can be considered a grantor of the data assets 308 within the data trust 304.

The data consumer 328 uses or accesses the data assets for analysis or other purposes. Depending on permissions of the data trust 304 implemented by the data trust system 300, a data consumer 328 may only be permitted to access some of the data assets 308.

The data trust 304 includes governance rules (rules and policies) that determine rights in respect of the data assets 308 for data consumers 328 and data providers 324. The rights may include ownership rights, access rights, remuneration, and the like. The governance rules are enforced by the data trust system 300.

In some cases, a data partner 310 may be a party to multiple data trusts 304.

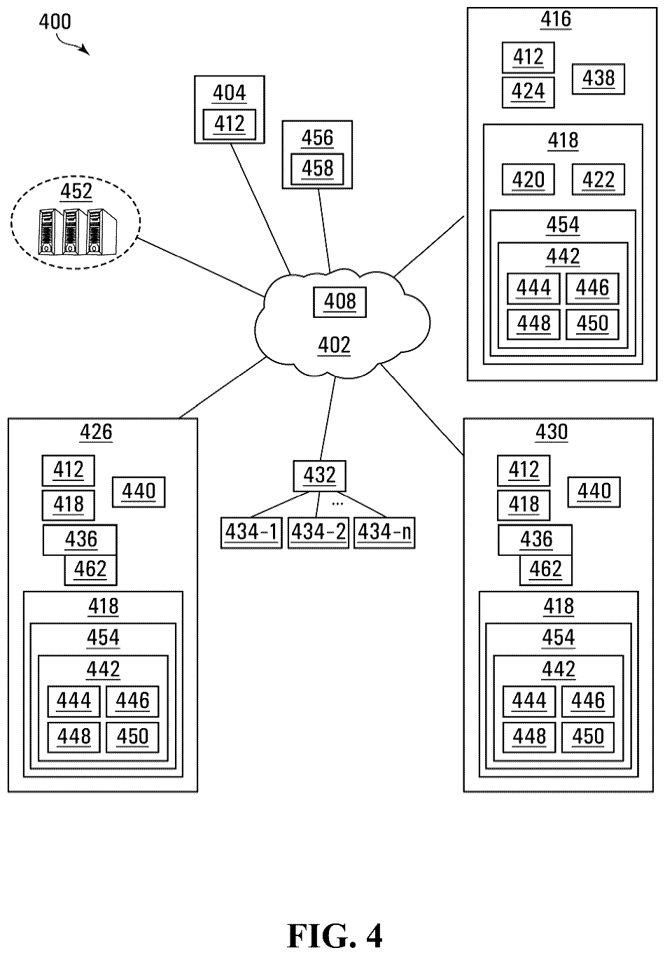

Referring now to FIG. 4, shown therein is a computer-implemented data trust system 400, according to an embodiment. The data trust system 400 can be used to provide a computer-implemented data trust (e.g. data trust 304 of FIG. 3) for a data asset.

The system 400 includes a data trust domain 402. The data trust domain 402 enables data flow and routing. The data trust domain 402 may be a form of network in which user (node) accounts and nodes are registered with a central database located on a domain controller or domain server 404. The data trust domain 402 is a network including a server acting as a domain controller.

The data trust domain 402 handles access policies, permissions, audit trails, and the like. The data trust domain 402 defines access rights, rules, and the like between data providers, data consumers, and data processors (e.g. data providers 324 and data consumers 328 of FIG. 3).

The system 400 includes a domain controller 404. The data trust domain 402 may include a group of clients and servers under the control of a central security database.

The domain server/controller 404 controls what the nodes in the data trust domain 402 (i.e. the members of the network) have access to (i.e. data assets). Domain nodes can be added to a list of acceptable computers stored on the domain controller 404.

In an embodiment, an administrator (e.g. trustee 316 of FIG. 3, administrator device 18 of FIG. 1) may add each node to the data trust domain 402 using administrator credentials (e.g. username and password). A trust party (e.g, trust party 312 of FIG. 3) may send access credentials to the domain controller 404. The domain controller 404 verifies the access credentials. Once the access credentials are verified, the domain controller 404 looks through a database and determines the permissions for the node (i.e. what data trust domain 402 resources the node can access) as well as security policies associated with the node. The domain controller 404 bundles the permissions and security information for the node into an access control key. The access control key is sent to the node. The node reads the access control key and determines what resources the node can access on the network 408.

The data trust domain 402 includes a plurality of nodes. The nodes in the data trust domain 402 are communicatively connected to each other via a network 408. The network may be a wide-area network (WAN). The network may be a private network (e.g. virtual private network or VPN).

In a particular embodiment, the network 408 is a software-defined wide area network (SD-WAN). The SD-WAN may be provided by a third party service (e.g. Cisco) or an open source product (e.g. open v-switch, open contrail). The system 400 may include a driver layer for the SD-WAN. The SD-WAN may be instantiated at the time the data trust domain 402 is created.

The SD-WAN simplifies the management and operation of a WAN by decoupling the networking hardware from its control mechanism. A centralized controller is used to set policies and prioritize traffic. The SD-WAN considers these policies and the availability of network bandwidth to route traffic. The SD-WAN contains a distributed ledger network. The distributed ledger network may be a permissioned blockchain network.

The SD-WAN may improve application performance through a combination of WAN optimization techniques and its ability to dynamically shift traffic to links with bandwidth sufficient enough to accommodate each application's requirements. The SD-WAN may use automatic failover, so if one link fails or is congested, traffic is automatically redirected to another link. This may boost application performance and reduce latency. The SD-WAN architecture may enable administrators to reduce or eliminate reliance on expensive leased MPLS circuits by sending lower priority, less-sensitive data over cheaper public internet connections, reserving private links for mission-critical or latency-sensitive traffic, like VoIP. The flexible nature of SD-WAN may reduce the need for over-provisioning, reducing overall WAN expenses. The SD-WAN may simplify the network 408 by automating site deployments, configurations and operations.

The nodes in the data trust domain 402 may receive a unique user account. The user account can be assigned access to resources (e.g. data assets) within the data trust domain 402. Smart cards and digital certificates may be used to confirm identities and protect stored information. In an embodiment, user requests are sent to the domain controller 404 for authentication and authorization. The domain controller 404 authenticates the user identity. Authentication may include validating a username and password. The domain controller 404 then authorizes requests for access accordingly.

Each node in the data trust domain 402 includes a network interface 412. In embodiments where an SD-WAN is used, the network interface 412 is an SD-WAN interface. The network interface 412 may include a network address. The network address may be a unique associated numerical label or identifier. The network interface 412 may provide network interface identification and location addressing for the node. In some cases, a node may be a member of multiple data trust domains. In such a case, the node may have multiple network interfaces 412 or addresses, with one network address for each data trust domain in which the node is a member.

The nodes in the data trust domain 402 include a parent node 416. The parent node 416 is associated with a trustee (e.g. trustee 316 of FIG. 3). The parent node 416 includes a distributed ledger node 418. In some cases, the creator of the data trust domain 402 may be automatically designated the trustee of the data trust. The trustee may be changed by assigning the data trust to another trust party. A party may be trustee for a defined period of time. The change of a trustee may have to be done in accordance with the governing rules of the data trust. For example, a change in trustee may require a vote among trust parties. The vote may require that the outgoing trustee abstain from the vote.

The parent node 416 includes a smart contract defining module 420. The smart contract defining module 420 is configured to define/generate a smart contract using governance rules of the data trust domain 402 as an input.

The parent distributed ledger node may include a validation module 422. The validation module 422 is configured to validate transactions on the distributed ledger.

The parent node 416 may include a governance rules module 424. The governance rules module 424 may be configured to receive governance rules data relating to remuneration, data asset access, visibility, domain joining/access, or the like, and generate a data trust governance rules output that can be provided to the smart contract defining module 420.

The nodes in the data trust domain 402 include a plurality of data partner nodes. The data partner nodes include at least one data provider node 426. The data provider node 426 is associated with a data provider (e.g. data provider 324 of FIG. 3).

The data provider node 426 transfers or “grants” some rights in respect of a data asset 428 within the data trust domain 402. The data asset 428 provided by the data provider node 426 may be a dataset, a derivative dataset, analytics, or a machine learning model. The data asset 428 may include a plurality of data assets. The data provider node 426 may include a distributed ledger node 418.

The data provider node 426 may be configured to receive some remuneration in exchange for provisioning the data asset 428 to the data trust domain 402. The remuneration may be fiat currency or cryptocurrency.

The data partner nodes include at least one data consumer node 430. The data consumer node 430 is associated with a data consumer (for example, data consumer 328 of FIG. 3). The data consumer node 430 is a beneficiary of the rights to the data asset 428 granted or transferred by the data provider node 426. The data consumer node 430 may include a distributed ledger node 418.

The data trust domain 402 may include a special node 432. The special node 432 may allow a mobile application 434 to communicate with the data trust domain 402, such as to put data into the data trust (as a data provider) or take data out of the data trust. The special node 432 may be provisioned on behalf of the trustee. In some cases, the special node 432 may be a data provider node 426 or data consumer node 430. The special node 432 may post an interface for facilitating communication between the mobile application (running on a mobile device) and the special node 432. The interface may be a REST interface.

One or more data partner nodes may be communicatively connected to an AI engine 436. The AI engine 436 is configured to perform a process related to the AI or machine learning lifecycle. The AI engine 436 is configured to generate one or more AI data assets. For example, the AI engine 436 may receive structured or unstructured data and generate one or more datasets from the received data. In another example, the AI engine 436 may generate a machine learning model using one or more datasets.

The AI engine 436 includes a plurality of machine learning algorithms. The machine learning algorithm can be used in a learning process. The AI engine 436 generates an output from the learning process. The output of the learning process is a machine learning model. The machine learning model has a predictive capability. The AI engine 436 can predict on data using the machine learning model.

The machine learning model, and thus the predictive capability, can be deployed to an application. For example, the AI engine 436 may be used to generate an ML model for predicting the likelihood of a given transaction being closeable in the next 90 days. The resulting ML model can be deployed to a CRM application for use by the application.

The AI engine 436 includes AI analytics tools. The AI analytics tools include machine learning algorithms. The AI analytics tools may include distributed deep analytics such as deep learning, probabilistic graph models ensembles, natural language processing, generative adversarial networks (GANs), and the like. The AI analytics tools may include recurrent neural networks. The RNNs may include many to many and many to one RNNs.

The AI analytics tools include distributed AI. The distributed AI may include analyzing data utilizing distributed AI, while supporting operationalization of analysis locally on a mass scale (assisting with triaging data and improving outcomes),and keeping data in place (i.e. performing learning and predictions across data notes while leaving data in place.

The AI analytics tools may include generic regression. The generic regression may include random forest, linear regression, MLP, partial least squares, Field-aware factorization machine, and the like.

The AI analytics tools include classification algorithms. The classification algorithms may include random forest, support vector machines, MLP, field-aware factorization machine, and the like.

The AI analytics tools may include object detection, such as SSD. The Al analytics tools may include image classification including VGG, ResNet, semantic segmentation, and the like. The AI analytics tools may include OCR. The OCR may be attention OCR. The AI tools may include sequence to sequence such as Seq2Seq. The AI tools may include AI container support.

The system 400, and in particular the Al engine 436, may utilize a container orchestration system or cluster orchestration system for automating application deployment, scaling, and management (e.g. Kubernetes). The system may provide a platform for automating deployment, scaling, and operations of application containers across clusters of hosts. The system may work with one or more container tools, such as Docker. The system may be deployed as a platform-providing service. For example, a Kubernetes-based platform may be provided via a cloud service.

In an example, the AI engine 436 may be configured to perform compute jobs (e.g. a prediction using an AI model). In some cases, the compute jobs may utilize Kubernetes objects. The container orchestration system may exert control over compute and storage resources by defining resources as objects (which can then be managed as such). Kubernetes Objects are persistent entities in the Kubernetes system. Kubernetes uses these entities to represent the state of your cluster. Kubernetes objects may describe, for example, what containerized applications are running (and on which nodes), the resources available to those applications, and the policies around how those applications behave, such as restart policies, upgrades, and fault-tolerance.

The Kubernetes objects may be used to represent containerized applications. The Kubernetes objects that represent the containerized applications run on top of a cluster. The cluster includes one or more cluster master and one or more nodes (e.g. worker machines that run containerized applications and other workloads). Each node is managed from the master. The cluster master runs Kubernetes control plane processes, which may include a Kubernetes API server, scheduler, and core resource controllers. The master is the unified endpoint for the cluster. Interactions with the cluster can be performed via Kubernetes API calls, and the master runs the Kubernetes API Server process to handle those requests. The cluster master is responsible for deciding what runs on all of the cluster's nodes. This can include scheduling workloads, like containerized applications, and managing the workloads' lifecycle, scaling, and upgrades. The master also manages network and storage resources for those workloads. The master and nodes also communicate using Kubernetes APIs.

The data trust is administered according to a set of governance rules 438. The governance rules 438 may include rules, policies, regulations, and the like regarding the data trust. The governance rules 438 may include rules or policies relating to the visibility of the data trust domain to potential nodes. The governance rules 438 may include rules or policies relating to access (or joining) to the data trust domain by potential nodes. The governance rules 438 may include rules or policies relating to access, ownership, or use rights in respect of the data assets 428. The governance rules 438 may include rules or policies relating to remuneration of a trust party (e.g. data provider).

In an embodiment, the data consumer node 430 may be communicatively connected to an AI engine 436. The data consumer node 430 may use the data asset 428 to which it has been granted access through the data trust domain 402 to generate a derivative data asset 440. The derivative data asset 440 may be a machine learning model trained using the data asset 428 (for example, if the data asset 428 is a dataset). The derivative data asset 440 may be provisioned to the data trust domain 402.

The set of governance rules 438 includes one or more rules or policies providing access to the data asset 428 from the data provider node 426 to the data consumer node 430. The set of governance rules 438 may include rules or policies relating to the remuneration of the data provider. The set of governance rules 438 may include rules or policies defining access rights of the data consumer to the data asset 428.

The governance rules 438 may be selectively or differentially applied to different data partners. For example, a data consumer may be permitted to access some data assets and not others. The data consumer may be permitted to access only a certain predictor (i.e. ML model) and not any datasets. A data consumer may only be permitted to access a data asset for a given period of time (e.g. the data consumer can access a predictor for 1 month). In such a case, the data consumer may be permitted to access the predictor after the expiry of the time period for a fee (i.e. a licensing fee). The fee may be payable in fiat currency or cryptocurrency (e.g. crypto tokens). The governing rules 438 may dictate that if a data consumer makes money off its use of a data asset (e.g. data asset 428) to which it has been given access through the data trust, the data consumer is required to pay one or more data partners (e.g. data provider node 426) a fee, which may be a percentage of profits from use of the data asset.

The set of governance rules 438 is defined in a smart contract 442. The smart contract 442 is a contract the terms of which are recorded in a computer language instead of legal language. The smart contract 442 can be automatically executed by the computing device (on which it is stored), which may be a suitable distributed ledger system.

The term “smart contract” is used herein to describe computer code that can facilitate the exchange of rights regarding the data assets. When running on the distributed ledger network 452, the smart contract 442 becomes like a self-operating computer program that automatically executes when specific conditions are met. Because the smart contract 442 runs on the distributed ledger network 452, the smart contract 442 runs exactly as programmed without potential for censorship, downtime, fraud or third-party interference.

The smart contract 438 includes a visibility module 444. The visibility module 444 may be executed when the data trust domain 402 receives a join attempt/request from a potential node (e.g. via the root network). The visibility module 444 determines whether the potential node is permitted to see the data trust domain 402. If the potential node is permitted to see the data trust domain 402, the visibility module 444 may generate a domain list including the data trust domain 402 using information retrieved from the root network (which includes the listing of data trust domains). The generated domain list is provided to the potential node.

The smart contract includes a domain joining module 446. The domain joining module 446 is configured to determine whether a potential node requesting to join the data trust domain 402 is permitted to join.

The smart contract 438 includes a data asset access module 448. The data asset access module 448 is configured to provide the data consumer node 430 with access to the data asset 428 in accordance with the governance rules 438 defined in the smart contract 432.

The smart contract includes a remuneration module 450. The remuneration module 450 is configured to provide remuneration to the data provider node 426 in exchange for providing access to the data asset 428.

The system 400 includes a distributed ledger network. The distributed ledger network may include a distributed ledger network 452 that is external to the domain 402. One or more nodes in the distributed ledger network 452 may be nodes in the data trust domain 402. The smart contract 442 is executed on the distributed ledger network 452.

The system 400 includes a distributed ledger 454. The distributed ledger 454 is implemented using the distributed ledger network 452. The distributed ledger 454 may provide an interprocess communication mechanism for the system 400. The distributed ledger 454 is a consensus of replicated, shared, and synchronized digital data geographically spread across multiple site, countries, or institutions. The distributed ledger 454 is distributed amongst the peer to peer or node network 452. The distributed ledger 454 is a database that is exists and is spread across several nodes or computing devices. In some cases, each node in the distributed ledger network 454 replicates and saves an identical copy of the ledger 454. Each participant node of the network 454 updates itself independently.

The distributed ledger 454 may be a blockchain. The blockchain employs a chain of blocks to provide a secure and valid distributed consensus. Data on the blockchain is grouped together and organized in blocks. The blocks are then linked to one another and secured using cryptography. The append-only structure of the blockchain allows data to be added to the database, while prevents altering or deleting previously entered data on earlier blocks. The role of a blockchain node is to support the blockchain network by maintaining a copy of a blockchain and, in some cases, to process transactions. The blockchain nodes may be arranged in the structure of trees (i.e. binary trees).

The distributed ledger network 452 may be a permissioned distributed ledger network. The permissioned network may permit only approved parties to run a node to validate transactions.

The distributed ledger network 452 may be a permissioned blockchain network. The permissioned blockchain may provide an interconnecting fabric between multiple nodes in the data trust domain 402. The permissioned blockchain may provide an access control mechanism so that peers are allowed or rejected based on a control value (an address, a certificate, etc.).

The permissioned distributed ledger may include an access control layer. The access control layer may control which nodes are permitted to participate in smart contract creation. The access control layer may control which nodes are permitted to participate in validation tasks.

In an embodiment, the distributed ledger network 452 is Ethereum. In another embodiment, the distributed ledger network 452 is Ethereum Quorum.

The distributed ledger network 452 may include a main chain and one or more sidechains. The main chain and sidechain are communicatively connected to one another. The main chain may be a public distributed ledger network (e.g. public blockchain). For example, the public blockchain network may be the Ethereum mainnet. Data assets (e.g. data assets 308) may be able to flow from the sidechain to the main chain and from the main chain to the side chain. In an embodiment, a smart contract may be used to link into the main chain (e.g. transfer of data assets between main chain and sidechain may be captured and controlled by a smart contract). This may provide visibility by leveraging Kubernetes jobs as first class citizens.

Integration a main chain (e.g. public blockchain) within the distributed ledger network 452 may provide increased operability between multiple data trusts 304 (i.e. intertrust operability). Such intertrust operability may facilitate chaining or linking multiple data trusts 304 into larger structures. For example, a first data trust (e.g. computer-implemented data trust 304) may be able to communicate with a second computer-implemented data trust through a parent blockchain or main chain. The second data trust may operate or be implemented according to the present disclosure.

The system 400 may include a zero-knowledge proof-based sidechain main chain integration.

The system 400 may include a zero-proof knowledge module comprising one or more software components configured to perform a zero-knowledge proof or implement a zero-knowledge proof-based protocol (e.g. zk-SNARK) on system data, and in particular on distributed ledger data. For example, computations related to the functioning of the distributed ledger components of the system 400 may implement zero-knowledge proofs. A zero-knowledge proof can be used to prove a computation without knowing what the computation is. For example, the zero-knowledge proof can be used to verify a blockchain or other distributed ledger transaction while maintaining user anonymity. The zero-knowledge proof module may be configured to use a digital watermark, hash, calculation, or the like of a computation of a sidechain.

Generally, the zero-knowledge proof implemented by the zero-knowledge proof module is a method by which one party (the prover) can prove to another party (the verifier) that they know a value x, without conveying any information apart from the fact that they know the value x.

The zero-knowledge proof may be a non-interactive zero-knowledge proof. The non-interactive zero-knowledge proof does not require interaction between a verifier and a prover. For example, when used in the system 400, the zero-knowledge proof module may be configured to prove that a transaction is valid without disclosing critical information, such as addresses and values involved. In an embodiment, logic of transactions may be validated [on public blockchain] while keeping values encrypted.

In variations of the system 400, trust party nodes may maintain a copy of the distributed ledger 454 and/or process transactions. In an embodiment, each trust party node (node in the data trust domain 402) maintains a copy of the distributed ledger 454. In another embodiment, only some of the trust party nodes in the data trust domain 402 maintain a copy of the distributed ledger 454. In another embodiment, only the parent node 416 maintains a copy of the distributed ledger 454.

In an embodiment, one or more trust party nodes in the data trust domain 454 are lightweight nodes. The lightweight node may not maintain a copy of the distributed ledger 454 or be able to process transactions. Lightweight nodes may connect to full nodes and transmit transactions to the distributed ledger network 452. The full nodes notify the lightweight nodes when a transaction affects the lightweight node. In an embodiment where the distributed ledger 454 is a blockchain, the lightweight node may only download the headers of all blocks on the blockchain. The use of lightweight nodes in the system may advantageously reduce download and storage requirements as compared to running a full node.

The system 400 includes a root network 456. The root network 456 is connected to the data trust domain 402 via the network 408. The root network 456 may be a centralized system.

The root network 456 is configured to store a list of data trust domains (“domain list”). The list of data trust domains allows a potential data partner node looking to join the data trust domain 402 to find the data trust domain 402 (in order to request to join). The data trust domain 402 is listed in the root network 456. Generally, once the data trust domain 402 is created, the data trust domain 402 is listed in the root network 456. Potential data partner nodes can call or contact the root network 456, if so provisioned.

The root network 456 includes a global lookup system 458. The global lookup system 458 provides a mechanism for a trust party node to find all the other nodes on the network 408. The global lookup system 458 may be configured to make sure that there are no collisions between the network addresses of the nodes, such as when a data partner is a data partner node on multiple data trust domains. The global lookup system (GLS) 458 may operate similarly to a DNS system. In an embodiment, the global lookup system 458 is maintained by a database system. The database system may be centralized or distributed. The distributed database system may use a client-server model. The database system includes one or more name servers. The name servers are nodes in the database system. Each domain may have at least one authoritative GLS server that publishes information about that domain and the name servers of any domains subordinate to it.

The system 400 may include a data policy enforcement engine 460. The system 400 includes a data policy enforcement engine. The data policy enforcement engine uses smart contracts to establish governance rules for the data trust. For example, a data partner (i.e. a data provider or consumer) can only join the data trust domain if the data partner is allowed to join by the policy framework defined in the smart contract set up by the trustee of the data trust domain.

The data consumer node 430 includes a user interface 462. The data asset 428 may be rendered in the user interface 462. The user interface 462 may be a point-and-click interface. The user interface 462 may be in communication with or a module of the Al engine 436. The rendered data asset 428 may be used by the Al engine 436 to generate the derivative data asset 440. The derivative data asset 440 may be rendered to the user interface 462.

The data provider node 426 includes a user interface 462. The data asset 428 may be rendered in the user interface 462. The user interface 462 may be a point-and-click interface. The user interface 462 may be in communication with or a module of the Al engine 436. The rendered data asset 428 may be used by the Al engine 436 to generate a derivative data asset. The derivative data asset may be rendered to the user interface 462.

The system 400 includes a value exchange system (e.g. the exchange of access to data assets in exchange for remuneration in fiat or cryptocurrency) built into the data trust to value the data assets between data providers and data consumers.

One or more nodes (e.g. data producer node 426, data consumer node 430) in the data trust domain 402 may include application hooks. The application hooks may be on the AI engine 436. The policy chain maintained within the distributed ledger 454 may be interrogated or interacted with from the application hooks. The application hooks may include external interaction points over standard protocols.

The system 400 advantageously allows the trust parties to define various rights relating to the data asset 428 with great specificity. The rights may relate to remuneration, access rights, licensing rights over profits from use of the data asset 428, and the like. The specificity is due to the governing rules 438 of the data trust (which cover these sorts of issues) being based on programming code that is declarative and consistent across all nodes.

The distributed ledger 454 allows the specification environment of the system 400 to have a transparent mechanism that the execution environment of the system 400 can connect into.

Aspects, features, and/or components of the system 400 may be combined into a thin wrapping. The thing wrapping includes the network 408 (e.g. SD-WAN). The thin wrapping may be wrapped around a point-and-click interface for accessing the AI engine 436.

In some embodiments, the system 400 may implement synthetic data techniques. Synthetic data techniques may be used to manufacture data with similar attributes to actual sensitive or regulated data. This may enable data professionals to use and share data more freely. The use of synthetic data by the system may be particularly advantageous in industries that include sensitive or regulated data such as financial or healthcare industries.

For example, the system 400 may create synthetic datasets to achieve complete privacy for a given analysis. The system 400 may create anonymized features of the real data for analysis, where the features are not traceable to individuals or companies. Such action by the system 400 may be performed on the systems of the data provider and then shared with the data trust domain 402. The system 400 may generate a full audit trail and tracking of the data usage and derivative data usage within the data trust using the distributed ledger 454 and the smart contract 442 definitions.

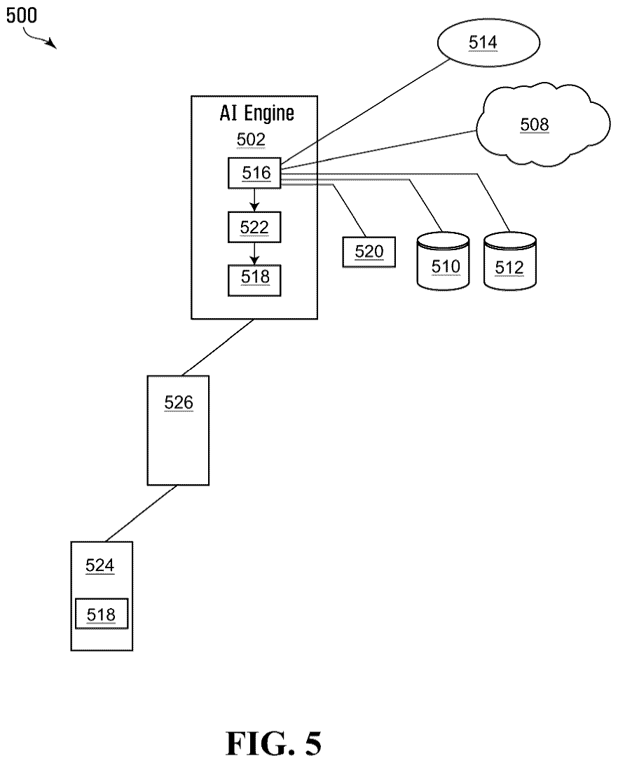

Referring now to FIG. 5, shown therein is an Al system 500, according to an embodiment.

The AI system 500 includes AI engine 502. The AI engine 502 may be AI engine 436 of FIG. 4. A given node in the data trust system 400 may include the AI engine 502 and/or implement the AI system 500 or a portion thereof.

The AI engine 502 may be used by a data provider (e.g. data producer 324 of FIG. 3) to generate a data asset (e.g. data asset 308 of FIG. 3).

The AI engine 502 may be used by a data consumer (e.g. data consumer 328 of FIG. 3) to perform analysis using a data asset. The analysis may generate a new data asset of the data consumer which may or may not be provisioned to the data trust (thus making the data consumer a data provider). The creation and/or use of a data asset by the AI engine 502 may include one or more compute jobs performed by the AI engine 502 (e.g. training a model, predicting on a model).

The AI engine 502 receives data from data sources 508, 510, 512, 514. The received data is used to create datasets 516. Datasets 516 can be used to train or develop one or more AI models. The AI engine 502 includes an AI toolkit 522. The AI toolkit 522 includes multiple ML algorithms. The data sets 516 can be input to an algorithm of the toolkit 522 and used in a learning process. The output of the learning process is a trained model 518 (e.g. an estimator) that has predictive capability.

In an embodiment, a client application 524 can call the AI engine 502 when the client application needs the predictive capability of the model 518. The AI engine 502 services the model 518 over a communication protocol 526 to the client application 524. The communication protocol 526 may be REST. REST is an architectural style or design pattern for APIs or for systems on the web to communicate with one another. The client application 524 may communicate with the Al engine 502 using an API. The API may be a REST API.

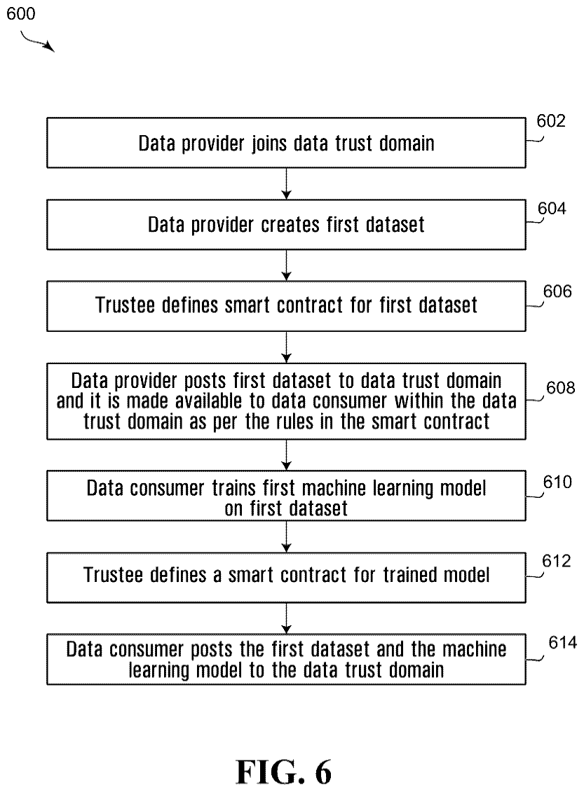

Referring now to FIG. 6, shown therein is a method 600 of using the data trust system 400 of FIG. 4, according to an embodiment.

At 602, a data provider (e.g. data provider 324 of FIG. 3) joins the data trust domain 402.

At 604, the data provider creates a first dataset. The first dataset is the data asset 428.

At 606, the trustee of the data trust (e.g. trustee 316 of FIG. 3) defines a first smart contract 442 for the data asset 428. The smart contract 442 includes rules 438 regarding who can access the data asset 428.

At 608, the data provider node 426 posts the data asset 418 to the domain 402. The data asset is made available to the data consumer node 430 in the data trust domain 430 according to the rules 438 in the smart contract 442.

At 610, the data consumer node 430 trains a machine learning (ML) model on the data asset 428 using the Al engine 436. The ML model is the derivative data asset 440.

At 612, the trustee defines a second smart contract 442 for derivative data asset 440. The smart contract 442 includes rules 438 regarding who can access the derivative data asset 440.

At 614, the data consumer node 430 posts the data asset 428 and the derivative data asset 440 to the data trust domain 402. The derivative data asset 440 is made available to other data consumer nodes 430 (which may include the data provider node 426, acting as a data consumer) according to the terms of the second smart contract 442.

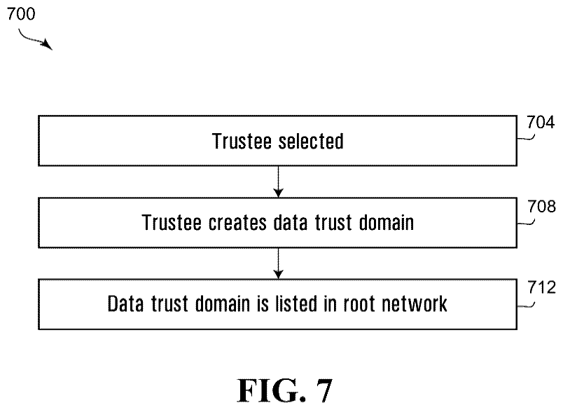

Referring now to FIG. 7, shown therein is a method 700 for creating a data trust using the system 400 of FIG. 4, according to an embodiment. By creating the data trust, a data asset can be made accessible to a data consumer from a data provider.

At 704, a trustee for the data trust is selected.

At 708, the trustee creates the data trust domain 402 for the data trust. Creating the data trust domain 402 generates the distributed ledger node 418 and the network 408 (SD-WAN). The distributed ledger node 418 sits in the network 408. The system 400 makes the trustee the parent node 416 on the network 408.

Other trust parties can try to join the data trust domain 402. In order to join, the trust party needs visibility to see the data trust domain 402.

At 712, the domain gets listed in the root network 456. The root network 456 maintains a list of the data trusts.

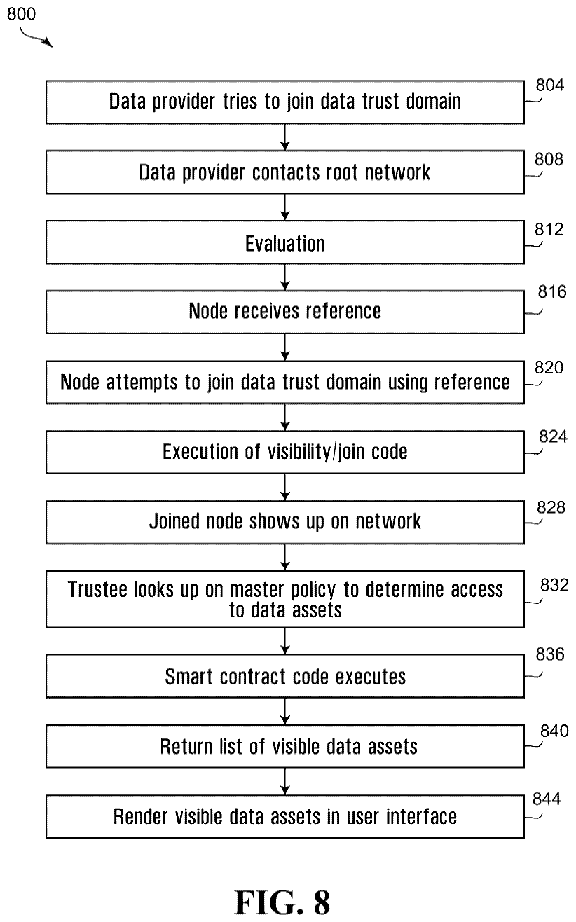

Referring now to FIG. 8, shown therein is a method 800 for joining a data trust (for example, the data trust created using method 600) using the system 400 of FIG. 4, according to an embodiment.

At 804, a data provider (e.g. data provider node 426) initiates an attempt to join the data trust domain 402.

At 808, a potential data partner node (e.g. data partner nodes 426, 430) contacts the root network 456 to determine if the node can see the data trust domain 402 (i.e. if the data trust is visible to that trust party). The node needs to be able to see the data trust in order to join the domain 402.

At 812, the contact from the node is received and the system 400 performs an evaluation. The evaluation determines if the node is permitted to see the data trust domain 402 (and thus attempt to join). The evaluation may take place in distributed code. If the evaluation is successful, the system 400 generates a handle or reference to the data trust domain 402. The reference is transmitted to the contacting node.

At 816, the potential node receives the reference to the data trust domain 402. The potential node can attempt to join the data trust domain 402 using the reference. The data trust domain 402 may be completely private. In such a case, the potential node may not be able to get a reference to the data trust domain 402. The potential node may be sent an email token or the like that performs the lookup process for the node.

At 820, the potential node attempts to join the data trust domain 402 using the reference.

At 824, the system 400 receives the attempt to join and executes the trustee's visibility code to determine if the requesting node can see the data trust domain 402. The system 400 also executes the trustee's join code to determine if the requesting node can join the data trust domain.

In some cases, the join code may require quorum approval of existing nodes in the data trust domain 402. For example, the join code may require that in order for the requesting node to join there must be quorum approval of 60% of the existing nodes in the data trust domain 402. This may include an asynchronous operation. For example, the system 400 may trigger a consent notification.

At 828, the permitted data partner node shows up as a joined node on the network 408 (SD-WAN).

At 832, the system 400 looks up on the trustee's master policy to determine what data assets (e.g. data asset 428) from the data trust domain 402 the joined data partner node is permitted to view and access (including the nature of access).

At 836, the smart contract 442 code executes.

At 840, the executed smart contract 442 code returns a list of data trust assets (e.g. data asset 428) that are visible and/or accessible to the joined data partner node.

At 844, the accessible data assets are rendered in the interface 462 of the data partner node as being visible.

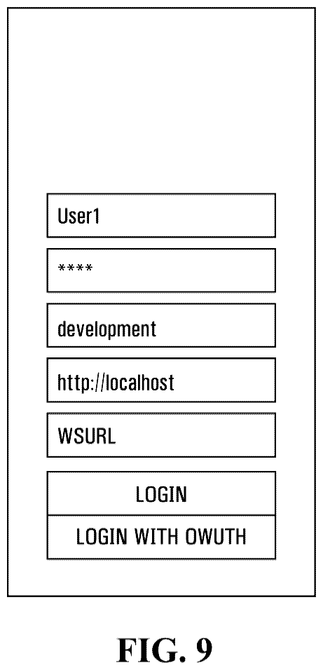

Referring now to FIGS. 9 to 28, shown therein are illustrative user interface screens illustrating how operators of the systems described herein can carry out the functionality of those systems. User devices of the system described in reference to FIGS. 9 to 28 include an AI engine (e.g. AI engine 500 of FIG. 5).

FIG. 9 provides an exemplary user interface landing page for logging into the data trust system. A first user can log into the system using the landing page.

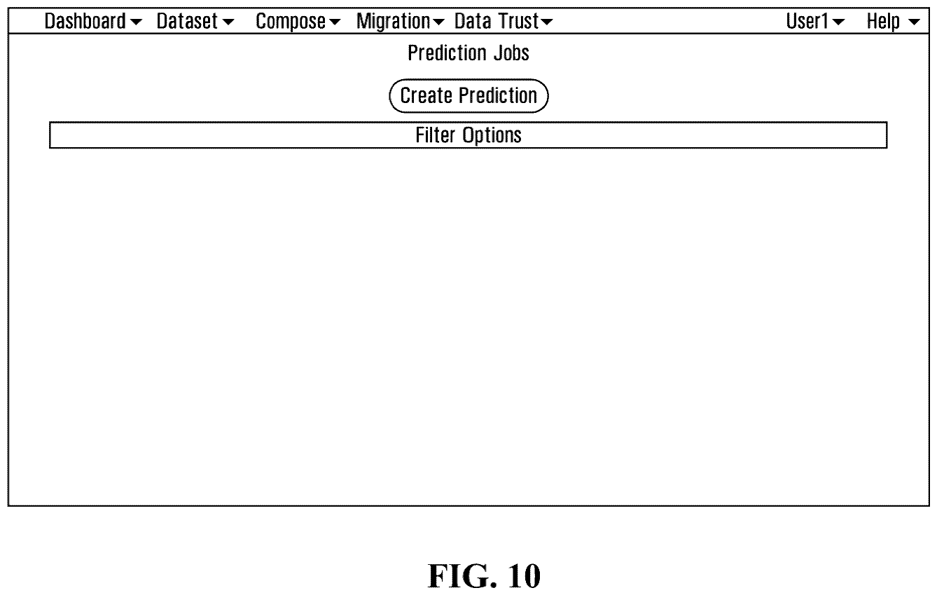

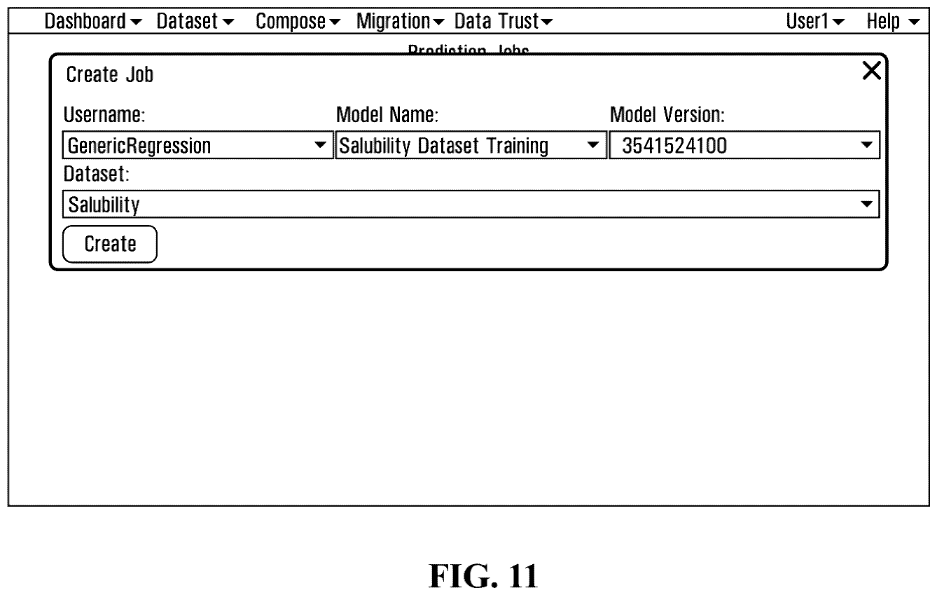

As shown in FIG. 10, the first user has a machine learning model indicated by the presence of a create prediction function in the user interface. As shown in FIG. 11, by selecting the create prediction, the system provides further details and options for using the model.

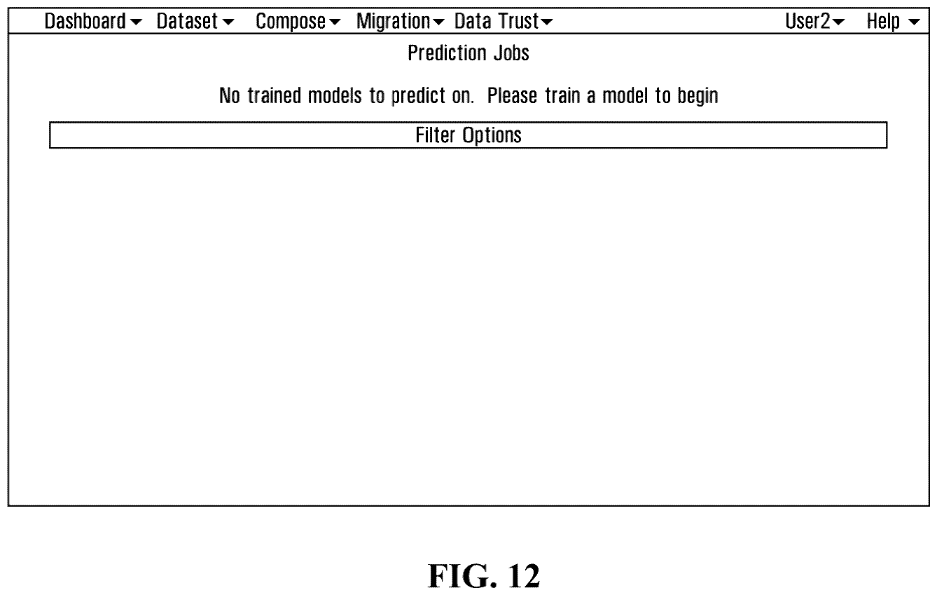

A second user can log into the system using the landing page of FIG. 9. As shown in FIG. 12, the second user does not have a machine learning model. This is indicated by the absence of a create prediction function in the user interface.

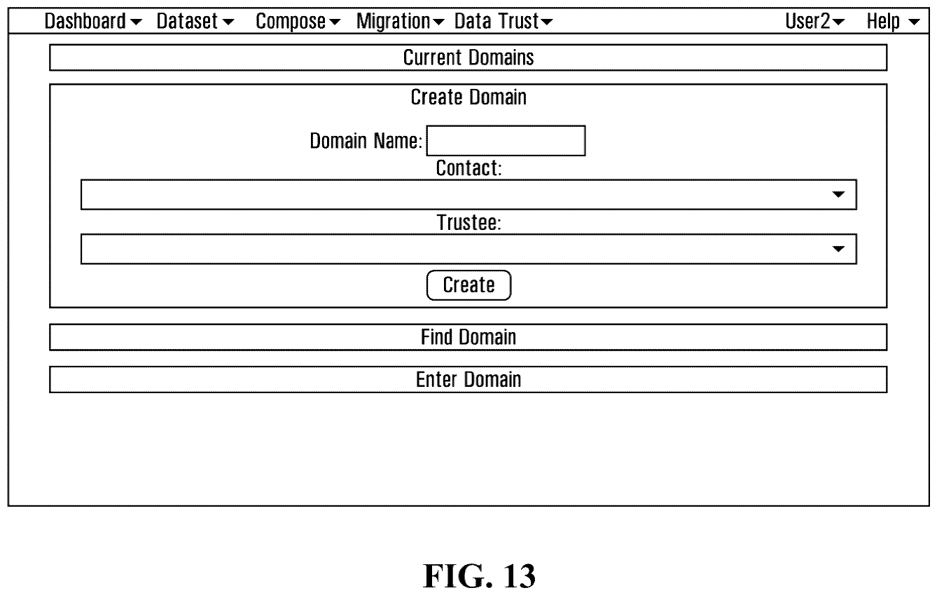

As shown in FIG. 13, the first user can create a data trust domain via a create domain function in the user interface. The first user can specify a domain name, a contract, and a trustee for the data trust domain. In this case, the contract is defined such that all data shared within the domain is stored on the blockchain and is available for use by all members of the data trust domain. The first user specifies itself as the trustee. The system may provide an alert that the data trust domain has been successfully created.

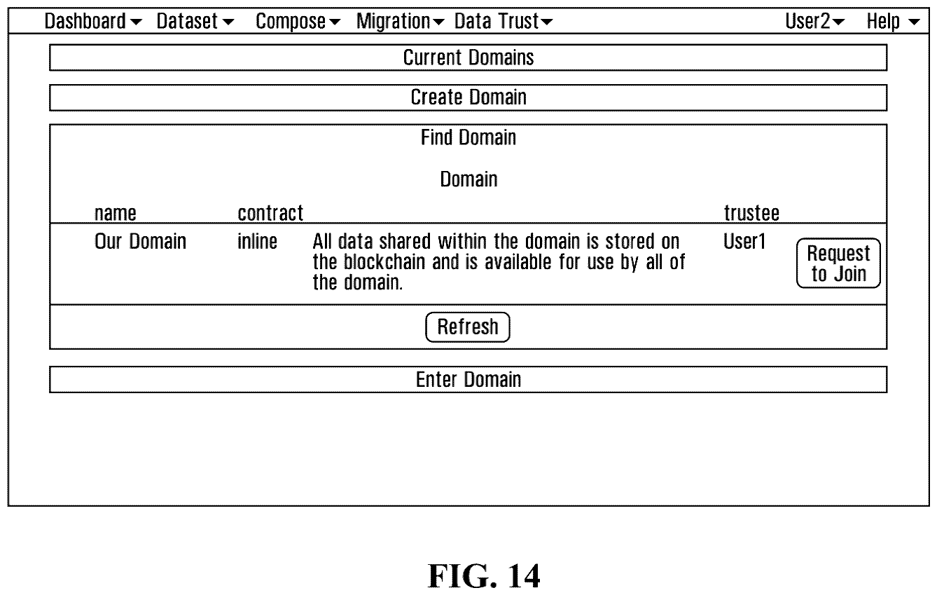

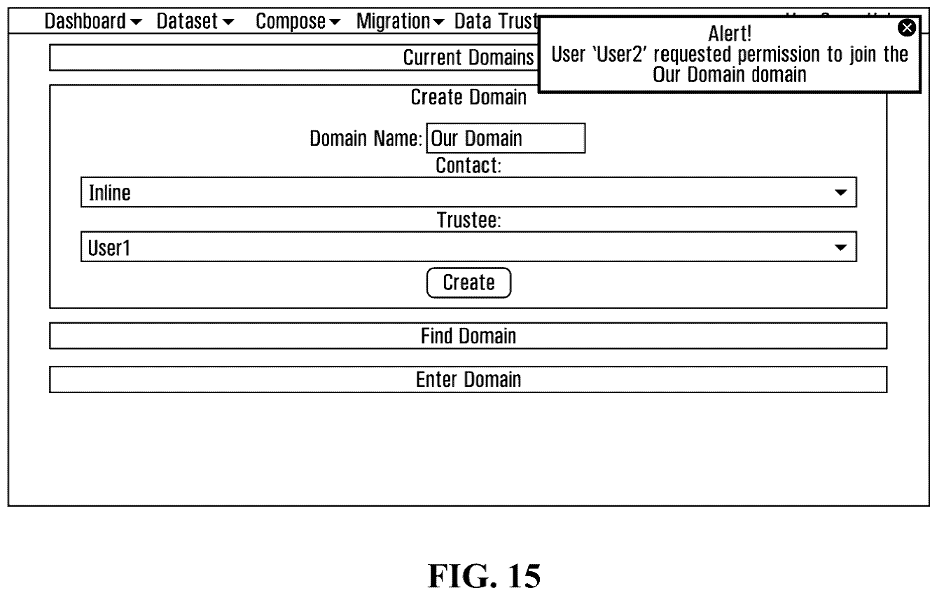

As shown in FIG. 14, the second user can search for the data trust domain created by the first user using a find domain function in the user interface. The found domains are listed in the user interface including information regarding the name of the domain, the contract, and the trustee. This information allows the second user to properly identify the data trust domain it wants to join. The second user can request to join the data trust domain. As shown in FIG. 15, the first user receives an alert from the second user asking to join the data trust domain.

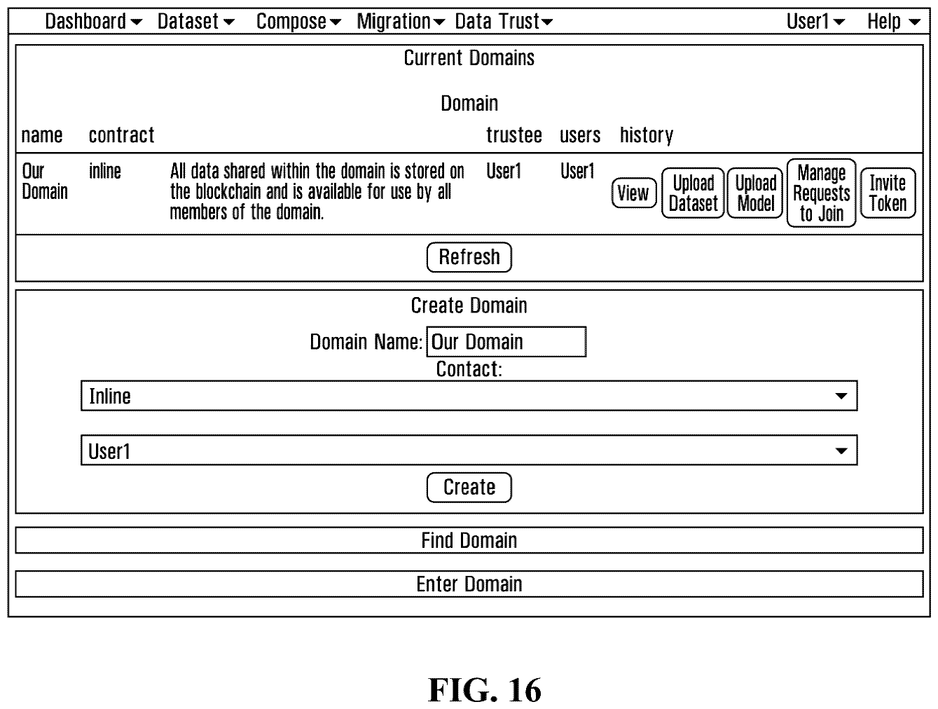

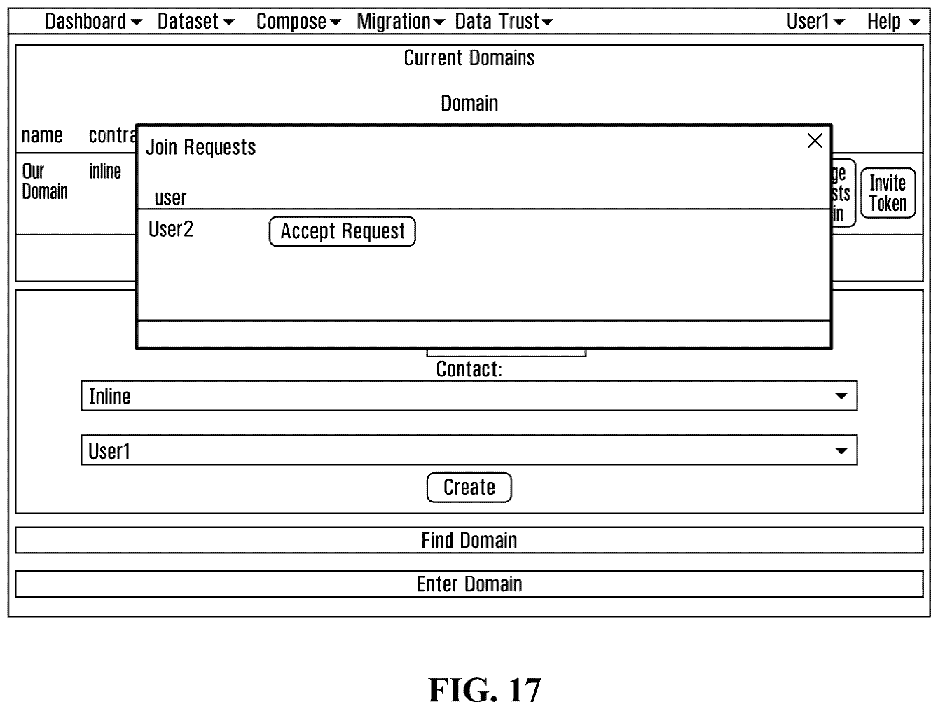

As shown in FIG. 16, the first user can manage the data trust domain via a current domains tab. Under the current domains tab, the first user can manage requests to join. As shown in FIG. 17, the manage requests indicates that the second user has asked to join the data trust domain. The first user can accept the request to join.

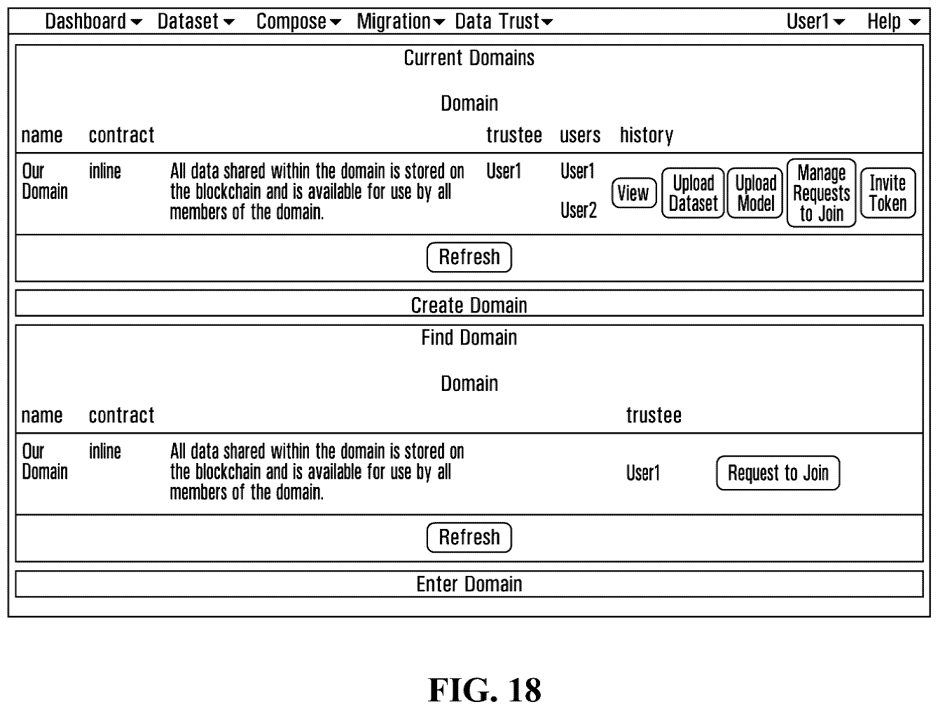

As shown in FIG. 18, once accepted, the data trust domain shows up under the current domains tab in the user interface of the second user. The list of users for the data trust domain includes the second user.

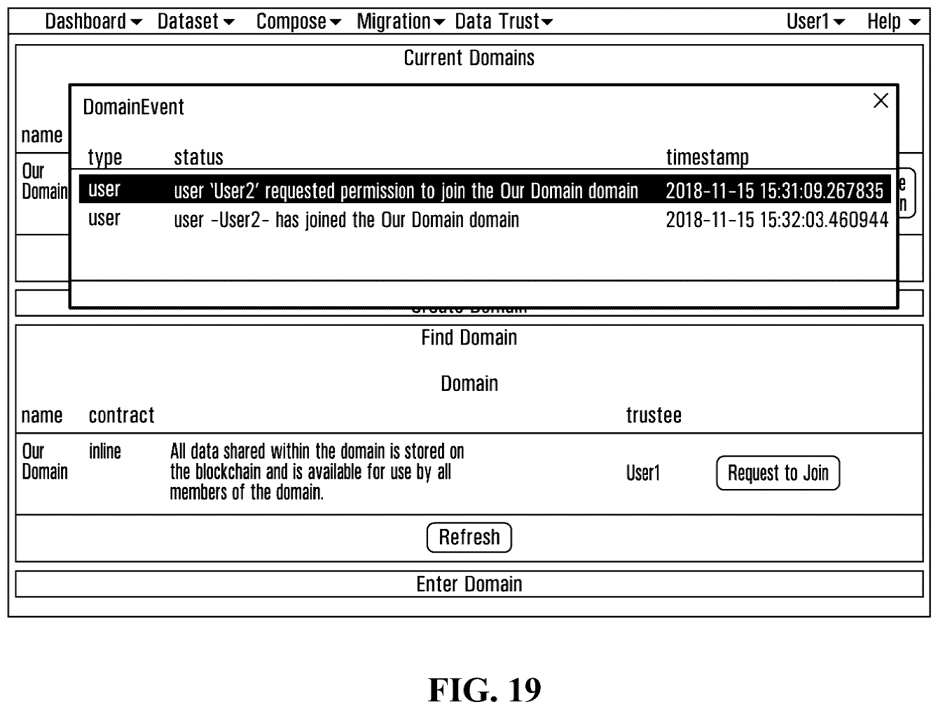

As shown in FIG. 19, the system maintains a listing of domain events. The domain events for the data trust domain include the second user request to join and joining of the second user.

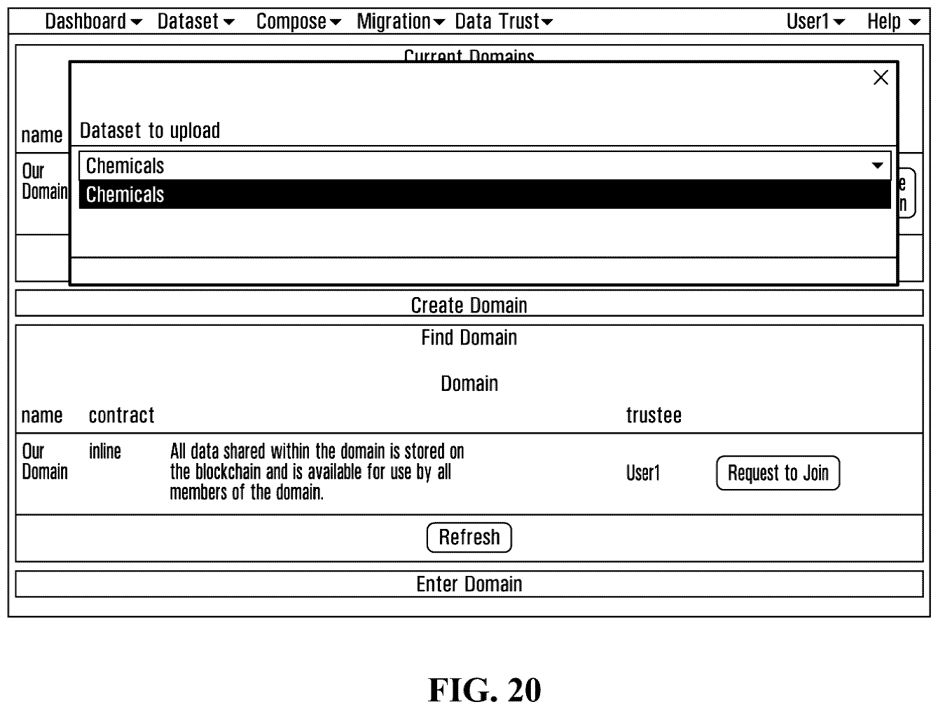

The second user has a first dataset (i.e. a data asset). Referring back to FIG. 18, the second user can select the upload dataset function in the user interface. As shown in FIG. 20, the system provides the second user with a list of datasets available to upload to the data trust domain. The second user can select the first dataset to upload.

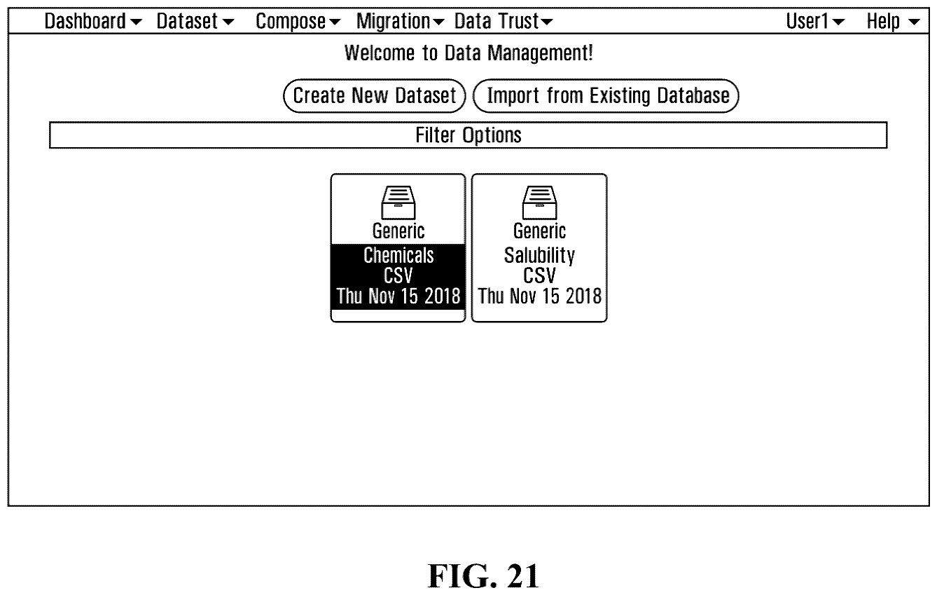

As shown in FIG. 21, the first user can go to a dataset manager page. The dataset manager page displays datasets available to the first user. The available datasets include the data assets of the first user and the shared dataset (the first dataset from the second user). The shared dataset has been made accessible to the first user according to the terms of the contract of the data trust domain (as specified in Figure x). Datasets may be colour-coded to indicate the source of the data.

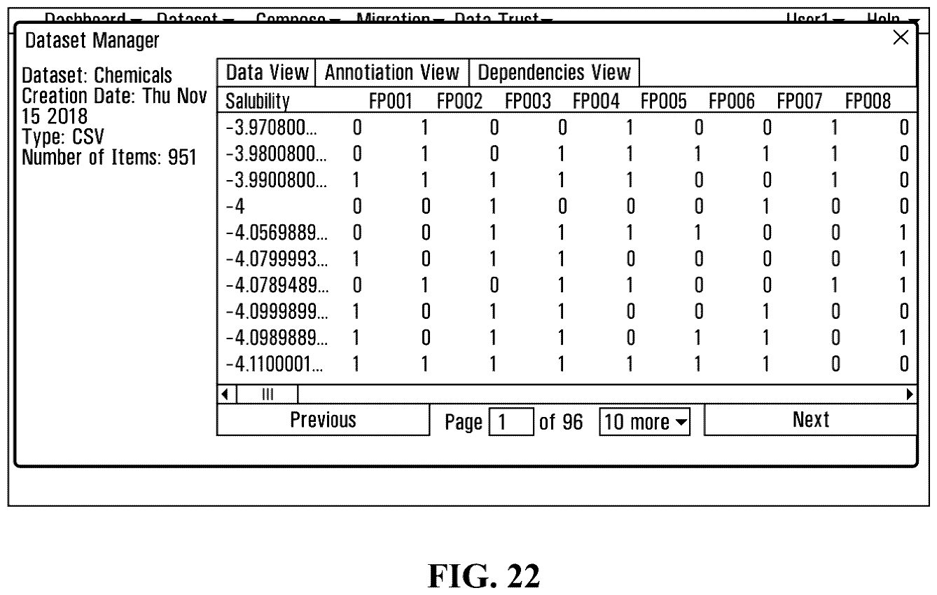

As shown in FIG. 22, the first user can open the shared dataset. The first user cannot delete the shared dataset (because it is from the data trust domain).

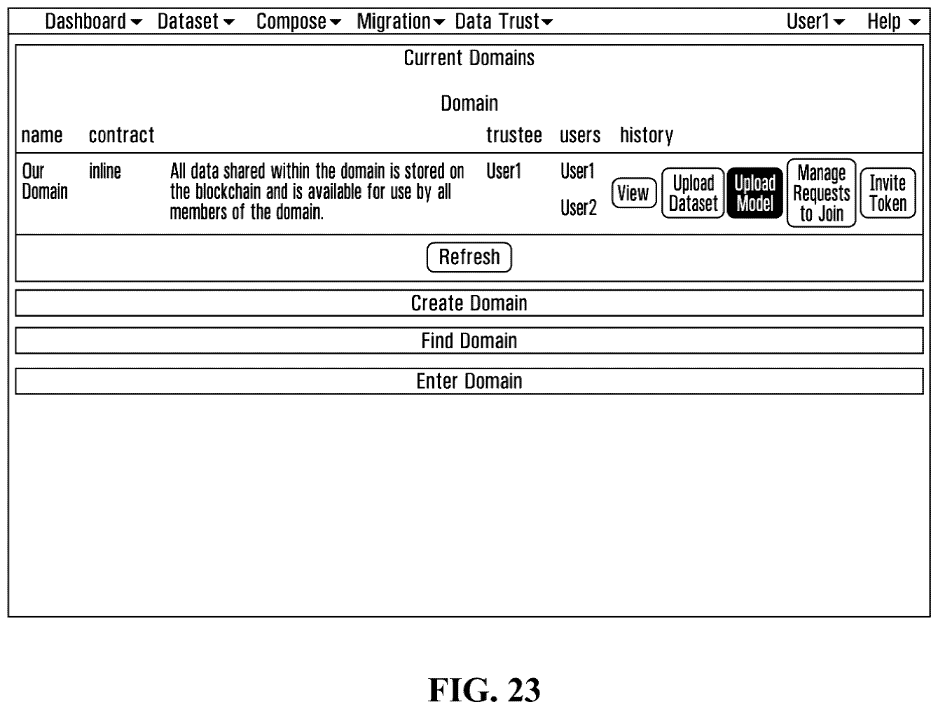

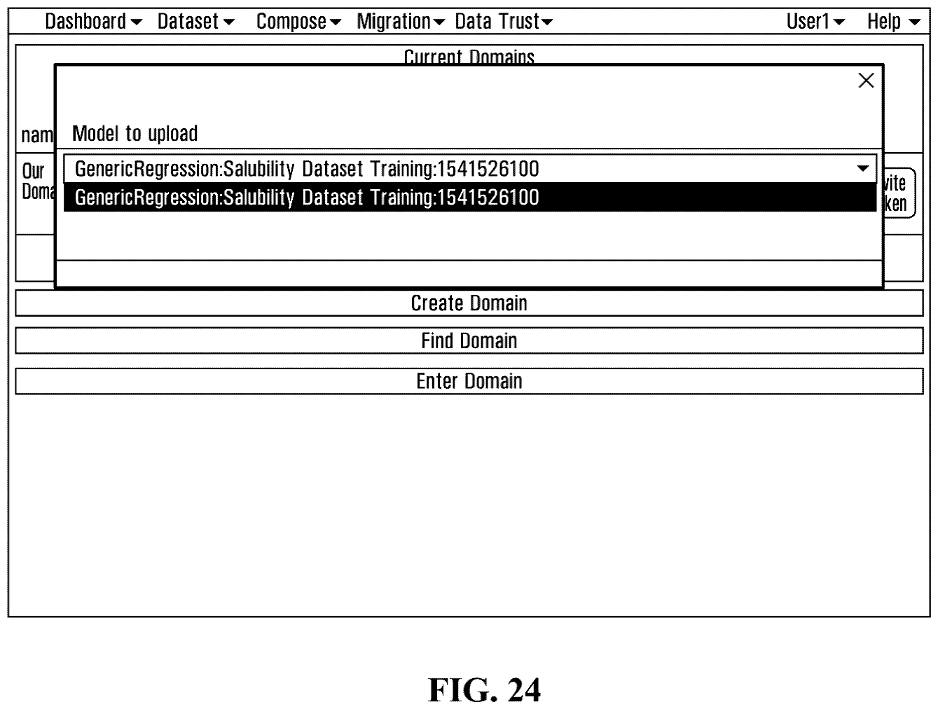

As shown in FIG. 23, the first user can share a machine learning model by uploading the model to the data trust domain. To do so, the first user can select the upload model function in the user interface. As shown in FIG. 24, the first user can select the model to upload from a list of available models.

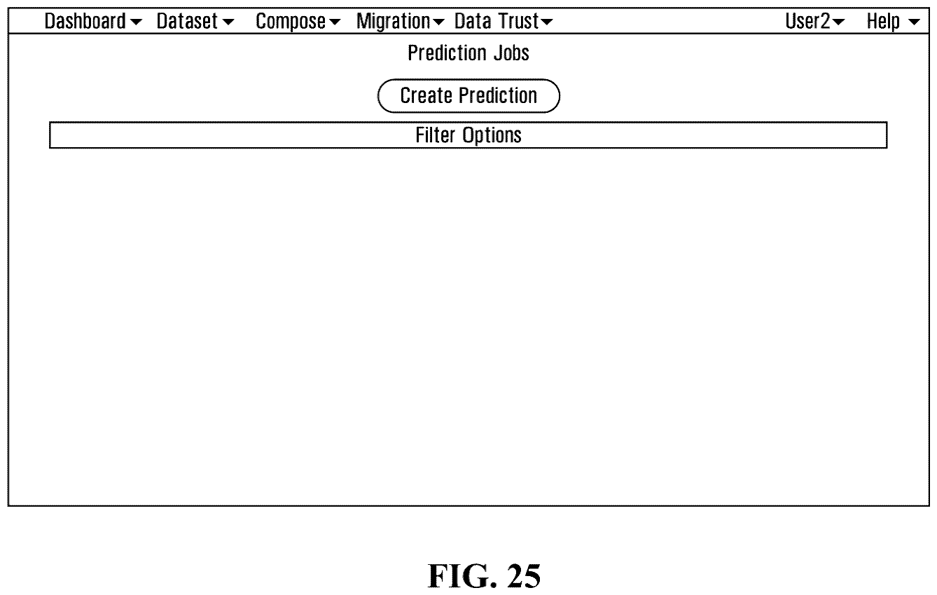

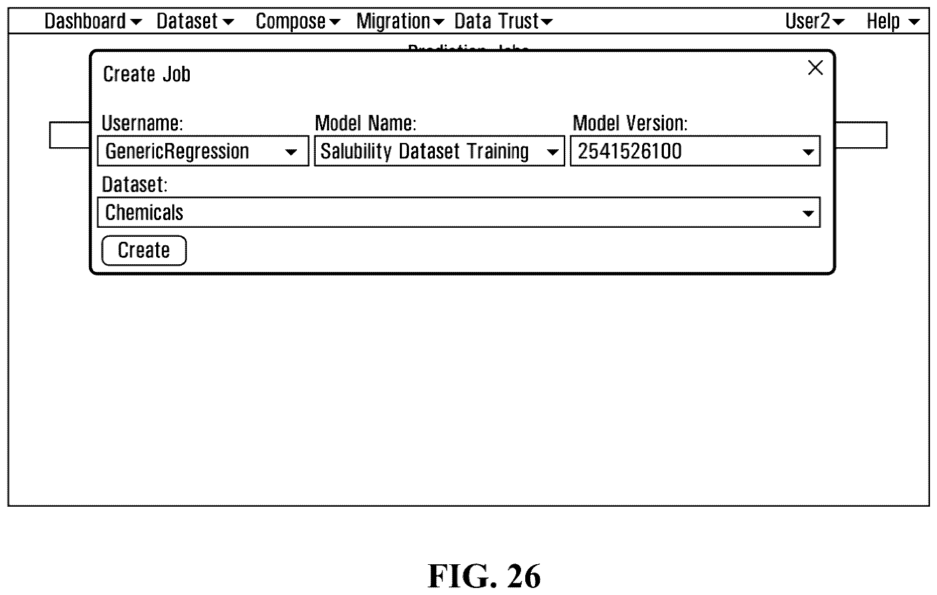

As shown in FIG. 25, the second user can access the model uploaded to the data trust system by the first user. This access is indicated by the presence of a create prediction function in the user interface. The second user can choose to create a prediction. As shown in FIG. 26, the second user can select the model shared by the first user from a list of available models. The second user can also select an available dataset (e.g. the first dataset).

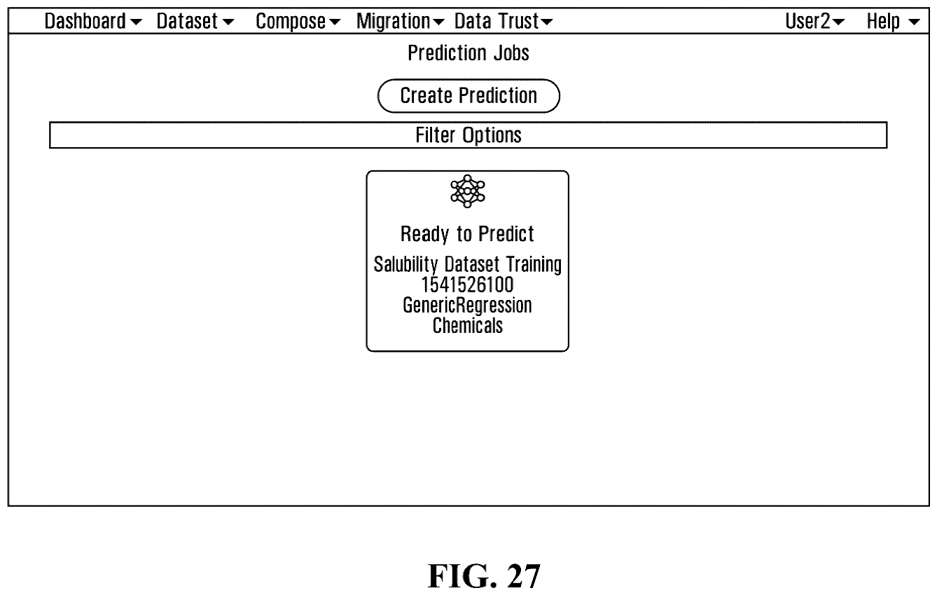

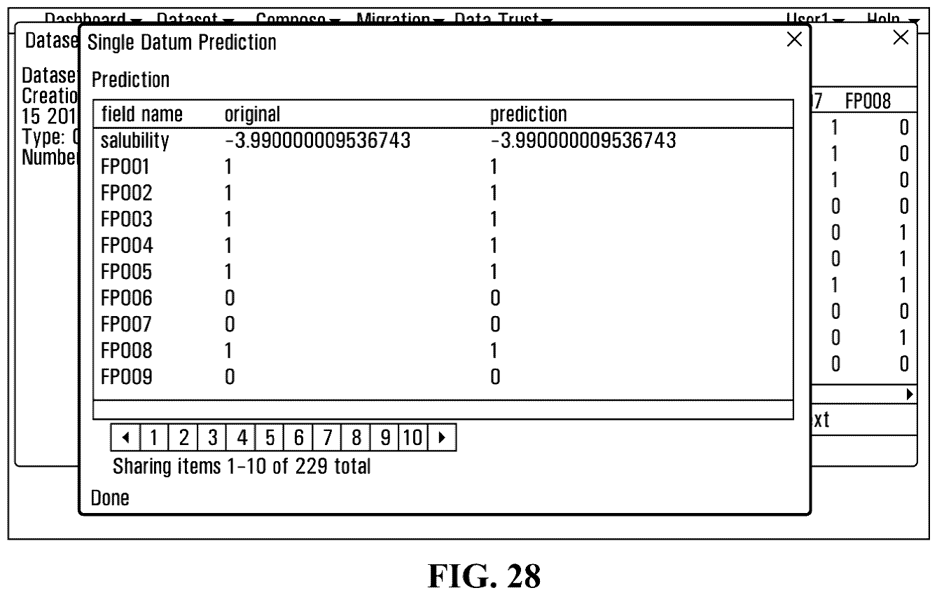

As shown in FIG. 27, the created prediction job appears in the user interface of the second user (under a prediction jobs tab). As shown in FIG. 28, by selecting the prediction job, the results of predicting on the model using the dataset are presented in the user interface of the second user.

In the foregoing example illustrated in FIGS. 9 to 28, the first and second users are data partner nodes in the data trust domain (the first user is also the parent node/trustee). The first and second users are data provider nodes because they share the model and first dataset, respectively, within the data trust domain. The first and second nodes are data consumer nodes as they have been given access to the first dataset and model, respectively, according the data trust domain contract.

Various implementations are contemplated for embodiments of the systems and methods. Some example implementations will be described below. The listed implementations are merely illustrative and are not limiting. Further implementations would be contemplated by those of skill in the art.

In variations, the systems and methods of the present disclosure may provide improved data sharing and exchange capabilities that, when applied or directed to problems in different application domains, can provide significant benefits and advantages.

As an example, in a particular case, the systems and methods described herein may be applied to problems associated with opioid abuse and the current opioid crisis (such as reducing opioid abuse-related deaths). Various entities represent contact points with the opioid epidemic, such as doctors, pharmacists, health insurance providers, first responders, etc. These entities may possess or acquire data assets that, if shared or exchanged in a controlled and efficient way, could be used to provide positive developments or solutions to the crisis, such as through the application of artificial intelligence or machine learning techniques.

Existing approaches for data sharing are time consuming and not well suited to address this and similarly sensitive issues. The time from when a decision is made to collaborate among entities in some sort of data sharing to the time the data is shared (considering contract evolution, lawyering, negotiation, physical transfer of the data by traditional means such as postal mail, etc.) may result in hundreds of opioid abuse-related deaths. These deaths may be preventable using a more efficient system for controlled sharing and exchange of data assets. The systems of the present disclosure advantageously address sources of friction in the implementation and management of collaborative data sharing or exchange arrangements between data partners, thereby reducing the time and costs (financial and otherwise) associated with such arrangements and processes. It will be appreciated that this particular application is merely a representative example of how the systems and methods of the present disclosure may provide real, tangible benefits over existing approaches and methods. The application of the systems and methods described herein to problems in other application domains to provide similar benefits and advantages are expressly contemplated and recognized.

More generally, the systems and methods of the present disclosure may improve the lives and prosperity of citizens through helping individuals, organizations and networks to control and derive value (economic, social, and cultural) from their data. The use of a common data trust architecture may lower the cost of entry for organizations to data-driven products, drive value for the producers of data (sovereignty, control, tradeable), and enhance outcomes, productivity, competitiveness for the customers of data.

The system may include data integration compatibility. Data source integration compatibility may include infrastructure (Hadoop, Firefox, JupyterHub), block chain (Ethereum, bitcoin), IOT (apache, kafka, storm), geoprocessing (GeoMesa, SNAP, Graph, GraphX, Neo4J).

Data type integration compatibility may include database (connect to structured or unstructured datastores, Microsoft SQL, IBM DB2, SAP Sybase ASE, PostgreSQL, MariaDB Enterprise, MySQL, Open Data Protocol compatibility, REST API compatibility), CSV/Text/MS Excel/MS Word documents and the like, remote sensor (IOT) data compatible, satellite digital imagery, ground sensor imagery, temperature/proximity/pressure.

The system may include enterprise security and compliance features including all internode (producer, consumer, trustee) communications are authenticated, all internode communication is encrypted, data auditing/processing/transaction logs.

The system may include enterprise application integration options. The system may include application development options such as Mobile App Developer SDK and Enterprise App Developer SDK. The system may make applications available via REST APIs or SDK (i.e. export to SAS Analytics tools). The system may facilitate custom integration with enterprise applications. The system may facilitate custom development of mobile or enterprise applications.

While the above description provides examples of one or more apparatus, methods, or systems, it will be appreciated that other apparatus, methods, or systems may be within the scope of the claims as interpreted by one of skill in the art.

1. A computer-implemented system for providing a data trust for a data asset, the system comprising:
a data trust domain comprising:
a parent node associated with a trustee, wherein the trustee administers the data trust;
a plurality of data partner nodes comprising:
at least one data producer node associated with a data producer;
at least one data consumer node associated with a data consumer;
wherein the nodes in the data trust domain are communicatively connected to each other via a network;
wherein the data trust is administered according to a set of governance rules, the set of governance rules defined in a smart contract;
wherein the smart contract is executed on a distributed ledger network; and
wherein access to the data asset is provided from the at least one data producer node to the at least one data consumer node according to the set of governance rules.

2. The system of claim 1, wherein any one or more of the parent node and at least one data partner node comprises a distributed ledger node.

3. (canceled)

4. The system of claim 1, wherein the network is a software-defined wide area network.

5. The system of claim 1, wherein the data trust domain is listed in a root network, wherein the root network is connected to the data trust domain via the network, and wherein the root network is configured to store a list of data trust domains.

6. The system of claim 5, wherein the root network is configured to maintain a global lookup system.

7. (canceled)

8. (canceled)

9. The system of claim 1, wherein the at least one data producer node is communicatively linked to an Al engine for generating the data asset.

10. The system of claim 1, wherein the at least one data consumer node is communicatively linked to an Al engine for generating a derivative data asset using the data asset.

11. The system of claim 10, wherein the derivative data asset is provisioned to the data trust domain.

12. The system of claim 1, wherein the distributed ledger network is a permissioned distributed ledger network.

13. The system of claim 12, wherein the permissioned distributed ledger comprises an access control layer.

14. The system of claim 13, wherein the access control layer controls which nodes are permitted to participate in smart contract creation.

15. The system of claim 13, wherein the access control layer controls which nodes are permitted to participate in validation tasks.

16. The system of claim 1, wherein the set of governance rules comprise at least one rule relating to remuneration of the data producer.

17. (canceled)

18. (canceled)

19. The system of claim 1, wherein the governance rules define access rights to the data asset for at least one data partner.

20. (canceled)

21. (canceled)

22. (canceled)

23. The system of claim 1, wherein the distributed ledger network includes a main chain and at least one sidechain

24. The system of claim 23, wherein the main chain is public, and wherein the system is configured to communicate with a computer-implemented data trust through the main chain.

25. A computing device for use in a computer-implemented data trust for a data asset, the computing device comprising:
a memory for storing the data asset; and
a computer processor;
wherein the computing device is a data partner node in a data trust domain;
wherein the computing device is communicatively connected to a plurality of other nodes in the data trust domain via a network, wherein the plurality of other nodes comprise:
a parent node associated with a trustee; and
at least one other data partner node;
wherein the data asset is subject to a smart contract, the smart contract defining a set of governance rules for the data trust; and
wherein the smart contract is executed on a distributed ledger network.

26. A method of providing controlled access to a data asset via a computer-implemented data trust, the method comprising:
creating a data trust domain, wherein the data trust domain comprises a plurality of nodes communicatively connected to each other via a network, and wherein the plurality of nodes comprise:
a parent node associated with a trustee, wherein the trustee administers the data trust, and wherein the parent node comprises a distributed ledger node;
a plurality of data partner nodes comprising:
at least one data producer node associated with a data producer;
at least one data consumer node associated with a data consumer;
defining a smart contract for the data asset, the smart contract defining a set of governance rules for the data asset; and
provisioning the data asset to the data trust domain in such a way that the data asset is accessible to the at least one data consumer node according to the smart contract.

27. The method of claim 26, wherein the network comprises a software-defined wide area network.

28. The method of claim 26, further comprising provisioning a second data asset to the data trust domain, the second data asset comprising a derivative data asset generated using the data asset.

29-31. (canceled)
